(19) United States
(12) Patent Application Publication
(10) Pub. No.: US 2013/0284978 A1
(43) Pub. Date: Oct. 31, 2013

(54) Polyheterosiloxane Composition Including Lanthanide Metal

(71) Applicants: David Deshazer, Bay City, MI (US); Martin Grasmann, Midland, MI (US); Lizhi Liu, Midland, MI (US); Nanguo Liu, Midland, MI (US); Elizabeth McQuiston, Midland, MI (US); Keith Shawn Mealey, Midland, MI (US); Randall Schmidt, Midland, MI (US)

(72) Inventors: David Deshazer, Bay City, MI (US); Martin Grasmann, Midland, MI (US); Lizhi Liu, Midland, MI (US); Nanguo Liu, Midland, MI (US); Elizabeth McQuiston, Midland, MI (US); Keith Shawn Mealey, Midland, MI (US); Randall Schmidt, Midland, MI (US)

(73) Assignee: Dow Corning Corporation, Midland, MI (US)

(21) Appl. No.: 13/996,709

(22) PCT Filed: Dec. 22, 2011
(86) PCT No.: PCT/US11/66890

§ 371 Date: Jun. 21, 2013

Related U.S. Application Data
(60) Provisional application No. 61/426,056, filed on Dec. 22, 2010.
(60) Provisional application No. 61/576,728, filed on Dec. 16, 2011.

(51) Int. Cl. C09K 11/06

(52) U.S. Cl. CPC C09K 11/06
USPC 252/301.35; 528/9

(57) ABSTRACT

A polyheterosiloxane composition includes (A) a first metal (M1), (B) a second metal (M2), and (C) siloxy units having the formula (R¹₃SiO_{1/2}), (R¹₂SiO_{2/2}), (R¹SiO_{3/2}), and/or (S1O_{4/2}). R¹ is independently a hydrocarbon or halogenated hydrocarbon group including 1 to 30 carbon atoms. The mole fractions of (A), (B), and (C) relative to each other is of the formula [(M1)]ₐ[(M2)]_{b}[R¹₃SiO_{1/2}]ₘ[R¹₂SiO_{2/2}]_{d}[R¹SiO_{3/2}]ₜ[SiO_{4/2}]_{q}, wherein a and b are each independently from 0.001 to 0.9, each of m, d, t, and q are independently from zero to 0.9 so long as m, d, t, and q are not all zero and the sum of a+b+m+d+t+q≈1. At least one of (M1) and (M2) is a lanthanide metal. The composition exhibits a quantum yield of at least 0.05% and is formed using a method including reacting (A′) a metal (M3) alkoxide, (B′) an optional hydrolyzable metal (M4) salt, (C′) a silicon-containing material and (D) water.

### BACKGROUND OF THE DISCLOSURE

Lanthanide metals are well-known for luminescence due to their electronic structures. Luminescent lanthanide metal doped materials are used in lasers, lighting, telecommunications, displays and sensors. For example, Er³⁺ doped glass fiber lasers can be excited with a 980 nm light source and emit light having a wavelength of 1.55 μm, and are an integral part of modem optical telecommunication networks.

The use of lanthanides metals in luminescent materials is limited by the standard energetic high temperature synthesis and blending and also by quenching of luminescence at high lanthanide concentration. Quenching can occur above a threshold lanthanide concentration where lanthanide metal ions are allowed to aggregate and subsequent coordinate changes in the electronic structure can lead to non-radiative routes to ground including cross relaxation. In some cases, excited state absorption can lead to quenching. Undetermined mechanisms, typically described as concentration quenching, may also occur. The threshold concentration for quenching can be as low as 1%, limiting the brightness of luminescent materials. Accordingly, there remains an opportunity to develop improved materials.

### SUMMARY OF THE DISCLOSURE

This disclosure provides a polyheterosiloxane composition. The polyheterosiloxane composition includes (A) a first metal (M1), (B) a second metal (M2), and (C) siloxy units having the formula (R¹₃SiO_{1/2}), (R¹₂SiO_{2/2}), (R¹SiO_{3/2}), and/or (SiO_{4/2}). In this formula, R¹ is independently a hydrocarbon or halogenated hydrocarbon group including 1 to 30 carbon atoms. Moreover, the mole fractions of (A), (B), and (C) relative to each other is of the formula [(M1)]ₐ[(M2)]_{b}[R¹₃SiO_{1/2}]ₘ[R¹₂SiO_{2/2}]_{d}[R¹SiO_{3/2}]ₜ[SiO_{4/2}]_{q}, wherein a is from 0.001 to 0.9, b is from 0.001 to 0.9, m is from zero to 0.9, d is from zero to 0.9, t is from zero to 0.9, and q is from zero to 0.9, m, d, t, and q cannot all be zero, and wherein the sum of a+b+m+d+t+q≈1. In addition, the composition exhibits a quantum yield of at least 0.05%. Moreover, at least one of (M1) and (M2) is a lanthanide metal.

This disclosure also provides a method of forming the polyheterosiloxane composition. The method includes the step of reacting (A′) a metal (M3) alkoxide, (B′) an optional hydrolyzable metal (M4) salt, (C′) a silicon-containing material having hydrolyzable groups chosen from (C′1) an organosiloxane and (C′2) a silane, and (D) an amount of water that provides between 50 and 200% necessary to hydrolyze and condense hydrolyzable groups of (A′) and (C′) and optionally (B′). In the method, at least one of (M3) and (M4) is a lanthanide metal.

The composition includes well dispersed metals because the metal bonded to the silicone matrix, as set forth in the formula. In addition, the metals may bond with one another, further increasing the variety of the metals, and therefore the quality of the dispersion of the metals, in the composition. The dispersion of the metals allows the composition to be luminescent such that excitation and emission spectra can be manipulated and customized based on choice of metal. In addition, the composition may be soluble in organic solvents which minimizes process complexities and time and reduces costs.

### BRIEF DESCRIPTION OF THE FIGURES

Other advantages of the present invention will be readily appreciated, as the same becomes better understood by reference to the following detailed description when considered in connection with the accompanying drawings.

FIG. 1 is an excitation and emission photoluminescence spectra of Example 26 at 10 wt % in toluene using a Jobin-Yvon SPEX Fluorolog2 device with a xenon lamp and 495 absorption filter. The excitation spectrum intensity is normalized to the peak height at approximately 395 nm, and is collected while monitoring the emission at 615 nm. The emission spectrum intensity is normalized to the peak height at 615 nm, and is collected while illuminating the sample with an excitation wavelength of 395 nm.

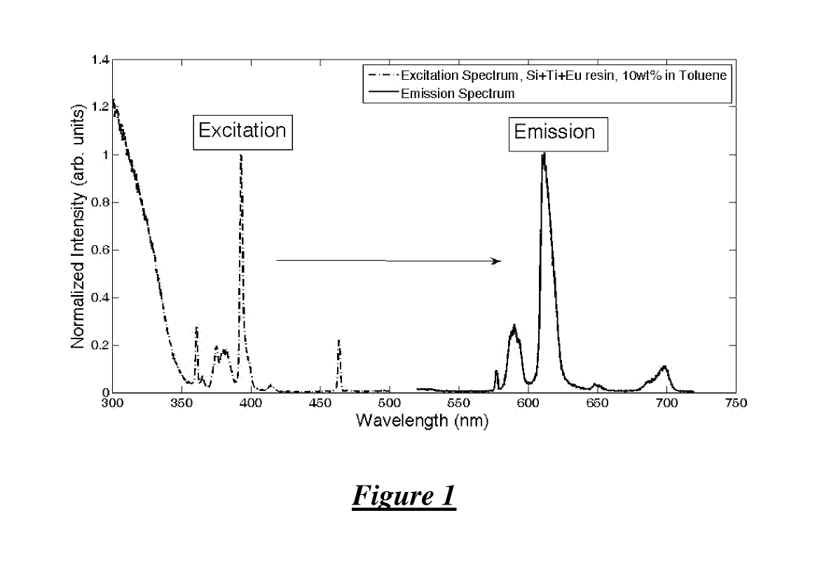

FIG. 2 is a TEM of Ti_{0.60}Eu_{0.03}D^{PhMe}_{0.27}T^{Ph}_{0.1} of Example 1.

FIG. 3 is a line graph illustrating excitation and emission spectra of Examples 1, 44, and 4 that include Eu, Tb and Dy, respectively.

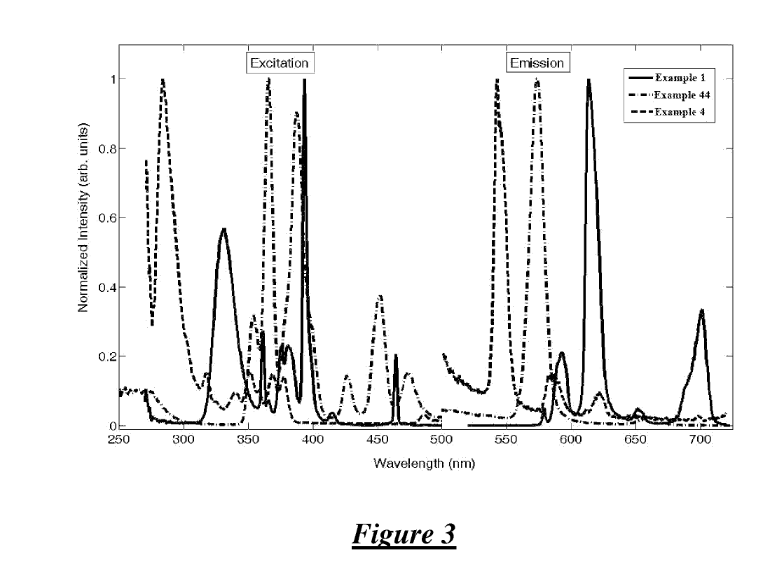

### DETAILED DESCRIPTION OF THE DISCLOSURE

This disclosure describes a polyheterosiloxane composition (hereinafter described as the “composition”) that includes (A) a first metal (M1), (B) a second metal (M2), and (C) siloxy units having the formula (R¹₃SiO_{1/2}), (R¹₂SiO_{2/2}), (R¹SiO_{3/2}), and/or (SiO_{4/2}), each of which is described in greater detail below.

### (A) The First Metal (M1):

The composition may include one (A) first metal (M1), two first metals (M1), or a plurality of first metals (M1). The (A) first metal (M1) is not particularly limited. In one embodiment, the (A) first metal (M1) is a lanthanide metal. In another embodiment, the (A) first metal (M1) is a non-lanthanide metal. In still another embodiment, the (A) first metal (M1) is chosen from Ti, Zr, and Al. In a further embodiment, the (A) first metal (M1) is chosen from Ti, Al, Ge, Zr, Sn, Cr, Ba, Sb, Cu, Ga, Hf, In, Fe, Mg, Mo, Nb, Y, Sr, Ta, Te, W, and V. Alternatively, the (A) first metal (M1) may be chosen from Ti, Zr, Al, Ge, Ta, Nb, and Sn. In another embodiment, the (A) first metal (M1) is chosen from La, Pr, Sm, Gd, Tb, Dy, Ho, Tm, and Lu. In still another embodiment, the (A) first metal (M1) is chosen from Gd, Tb, Dy, Ho, Tm, and Lu. In an even further embodiment, (M1) is chosen from Eu, Yb, Er, Nd, Dy, Sm, and Tb. The oxidation state of first metal (M1) may independently range from 1 to 7, from 1 to 5, or from 2 to 4. If more than one (A) first metal (M1) is utilized, then each (M1) may independently have the same or different oxidation states.

In various embodiments, atoms of first metal (M1) may be bonded to atoms of first metal (M1), second metal (M2), and/or one or more (C) siloxy units. For example, atoms of first metal (M1) may be linked via oxygen atoms to atoms of first metal (M1) and/or second metal (M2), e.g. M1-O-M1-O-M2 or M1-O-M2. Atoms of first metal (M1) may also have a one or more substituents bonded thereto such as residual or un-reacted substituents used to form the composition, as described in greater detail below.

### (B) The Second Metal (M2):

The composition may include one (B) second metal (M2), two second metals (M2), or a plurality of second metals (M2). The (B) second metal is also not particularly limited except that at least one of first metal (M1) and second metal (M2) is or includes a lanthanide metal. In one embodiment, the second metal (M2) is chosen from Er and Zn. In another embodiment, the (B) second metal (M2) is a lanthanide metal. In still another embodiment, the (B) second metal (M2) is a non-lanthanide metal. Alternatively, the (B) second metal may be any one of the aforementioned metals described above relative to first metal (M1). For example, first metal (M1) and second metal (M2) may be one of the following:

| First Metal (M1) | Second Metal (M2) |
|---|---|
| Lanthanide Metal | Non-Lanthanide Metal |
| Combination of one or more | Non-Lanthanide Metal |
| Lanthanide Metals and one or | |
| more Non-Lanthanide Metals | |
| Non-Lanthanide Metal | Lanthanide Metal |
| Non-Lanthanide Metal | Combination of one or more |
| | Lanthanide Metals and one or |
| | more Non-Lanthanide Metals |
| Combination of one or more | Combination of one or more |
| Lanthanide Metals and one or | Lanthanide Metals and one or |
| more Non-Lanthanide Metals | more Non-Lanthanide Metals |

Just as above, in various embodiments, atoms of second metal (M2) may be bonded to other atoms of second metal (M2), first metal (M1), and/or one or more (C) siloxy units. For example, atoms of second metal (M2) may be linked via oxygen atoms to atoms of second metal (M2) and/or first metal (M1), e.g. e.g. M2-O-M2-O-M1 or M2-O-M1. Atoms of second metal (M2) may also have a one or more substituents bonded thereto such as residual or un-reacted substituents used to form the composition, as described in greater detail below.

Each of (M1) and/or (M2) may independently include one or more lanthanide and/or non-lanthanide metals, singly or in combination, so long as at least one of (M1) and (M2) is or includes a lanthanide metal. In various embodiments, one or more lanthanide metals are utilized. In other embodiments, a mixture of non-lanthanide metals is utilized with one or more lanthanide metals. For example, (M1) and/or (M2) may include or be a combination of Eu and Y, Eu and La, Eu and Ce, Eu and Gd, Eu and Tb, Eu and Dy, Eu and Sm, Ce and Tb, Tb and Yb, Er and Yb, Pr and Yb, Tm and Yb, and/or combinations thereof. In other embodiments, (M1) and/or (M2) may include or be Ti, Zr, Al, Ge, Ta, Nb, Sn, Hf, In, Sb, Fe, V, Sb, W, Te, Mo, Ga, Cu, Cr, Mg, Ca, Ba, Sr, Y and Sc and/or combinations thereof. In further embodiments, (M1) and/or (M2) may include or be Ti, Al, Ge, Zr, Sn, Cr, Ca, Ba, Sb, Cu, Ga, Hf, In, Fe, Mg, Mo, Nb, Ce, Y, Sr, Ta, Te, W, V, Sc, La, Pr, Nd, Pm, Sm, Eu, Gd, Tb, Dy, Ho, Er, Tm, Yb, and Lu and/or combinations thereof.

### (C) Siloxy Units:

The composition also includes (C) siloxy units having the formula (R¹₃SiO_{1/2}), (R¹₂SiO_{2/2}), (R¹SiO_{3/2}), and/or (SiO_{4/2}). These units may be alternatively described as organopolysiloxane segments and are known in the art as M, D, T, and Q units, respectively. In one embodiment, the composition includes “M” siloxy units. In another embodiment, the composition includes “D” siloxy units. In still another embodiment, the composition includes “T” siloxy units. In a further embodiment, the composition includes “Q” siloxy units. In even further embodiments, the composition includes “M” and “D” units, “M” and “T” units, “M” and “Q” units, “D” and “T” units, “D” and “Q” units, or “T” and “Q” units.

In the formulae above, R¹ is independently a hydrocarbon or halogenated hydrocarbon group including 1 to 30, 1 to 20, 1 to 15, 1 to 12, 1 to 10, or 1 to 5, carbon atoms. Non-limiting examples include alkyl groups such as methyl, ethyl, propyl, butyl, pentyl, hexyl, heptyl, octyl, undecyl, and octadecyl groups; cycloalkyl groups such as cyclohexyl; aryl groups such as phenyl, tolyl, xylyl, benzyl, and 2-phenylethyl; and halogenated hydrocarbon groups such as 3,3,3-trifluoropropyl, 3-chloropropyl, and dichlorophenyl groups. The number of siloxy units may vary. The number and type of siloxy units may affect the molecular weight of the organopolysiloxane segment, and hence the molecular weight of the composition.

In various embodiments, the (C) siloxy units include greater than 50 mole or weight percent of R¹SiO_{3/2} siloxy units where R¹ is phenyl; R¹₂SiO_{2/2} siloxy units where one R¹ substituent is phenyl, and the other R¹ substituent is methyl; or R¹₂SiO_{2/2} and R¹SiO_{3/2} siloxy units where one R¹ substituent in the R¹₂SiO_{2/2} siloxy unit is phenyl, and the other R¹ substituent is methyl, and where R¹ is phenyl in the R¹SiO_{3/2} siloxy unit. In still other embodiments, the siloxy units have the formula [(C₆H₅)SiO_{3/2}]_{d}, [(C₆H₅)₂SiO_{2/2}]_{c}[(C₆H₅)SiO_{3/2}]_{d}, or [(CH₃)(C₆H₅)SiO_{2/2}]_{c} [(C₆H₅)SiO_{3/2}]_{d}.

### Amounts of (A), (B), and (C):

The composition may include at least 1, 5, 10, 15, 20, 25, 30, 35, 40, 45, 50, 55, 60, 65, 70, 75, 80, 85, 90, 95, or at least 98 or 99,%, of (A), (B), and (C) based on a total weight of the composition. Alternatively, the composition may include approximately 100% of (A), (B), and (C) based on a total weight of the composition. It is also contemplated that any range of values including those above, or any one or more values between those above, may also be utilized. Any remaining percent by weight of the composition may include one or more solvents, one or more counterions, e.g. benzoates, naphtoates, and acetates, and/or one or more components used to form the composition.

The varied amounts of each of (A), (B), and (C) is typically described relative to mole fractions of each to a total number of moles of (A), (B), and (C) present in the composition. For example, the mole fractions of (A), (B), and (C) in the polyheterosiloxane composition relative to each other is of the formula [(M1)]ₐ[(M2)]_{b}[R¹₃SiO_{1/2}]ₘ[R¹₂SiO_{2/2}]_{d}[R¹SiO_{3/2}]ₜ[SiO_{4/2}]_{q}. In this formula, the subscript m denotes the mole fraction of the optional “M” unit (R¹₃SiO_{1/2}). The subscript d denotes the mole fraction of the optional “D” unit (R¹₂SiO_{2/2}). The subscript t denotes the mole fraction of the optional “T” unit (R¹SiO_{3/2}). The subscript q denotes the mole fraction of the optional “Q” unit (SiO_{4/2}).

This formula makes it clear that (MD and (M2) are bonded to the same or different silicon atoms, e.g. through an oxygen bond. In this formula, a and/or b is each independently from 0.001 to 0.9, 0.010 to 0.9, 0.001 to 0.7, 0.1 to 0.7, 0.1 to 0.6, 0.2 to 0.5, 0.2 to 0.8, 0.3 to 0.7, 0.4 to 0.6, or about 0.3, 0.4, 0.5, 0.6, 0.7, 0.8, or 0.9. Alternatively, a and/or b may be each independently from 0.001 to 0.9, 0.001 to 0.5, 0.01 to 0.3, or 0.05 to 0.25. In one embodiment, when (M1) is a non-lanthanide metal and (M2) is a lanthanide metal, a is from 0.1 to 0.9 and b is from 0.001 to 0.5. In addition, in additional embodiments, the total metal content of the composition, i.e., the sum of a+b, may be from 0.1 to 0.9, from 0.2 to 0.8, from 0.3 to 0.7, from 0.4 to 0.6, about 0.3, 0.4, 0.5, 0.6, 0.7, 0.8, or 0.9, mole fraction.

Moreover, in the aforementioned formula, m is from zero to 0.9, 0.1 to 0.6, or 0.2 to 0.5. d is from zero to 0.9, 0.1 to 0.5, or 0.1 to 0.3. Each of t and q is independently from zero to 0.9, 0.010 to 0.9, 0.001 to 0.7, 0.1 to 0.7, 0.1 to 0.6, or 0.2 to 0.5. Moreover, m, d, t, and q cannot all be zero and the sum of a+b+m+d+t+q≈1. The terminology “≈” describes that the sum of a, b, m, d, t, and q is approximately equal to 1. For example, in various embodiments, the sum may be 0.99, 0.98, 0.97, 0.96, 0.95, etc. If the sum does not equal 1, then the composition may include residual amounts of groups that are not described by the aforementioned formula. As just one non-limiting example, the composition may include up to about 5 mole percent of other units, such as those that include Si—OH bonds.

The number of moles of each in the composition may be determined using common analytical techniques. The number of moles of both first metal (MD and second metal (M2) in the composition may be determined using common elemental analysis techniques. The number of moles of the siloxy units may be determined by ²⁹Si NMR. Alternatively, the number of moles of each may be calculated from the amounts of each used in the process to prepare the composition, and accounting for any losses (such as removal of volatile species) that may occur during the process.

For example, the composition may also include from 1 to 70, 1 to 60, 1 to 50, 1 to 40, 1 to 30, 1 to 20, from 1 to 15, from 1 to 10, or from 1 to 5, percent by weight alkoxy groups. Residual alkoxide (—OR) groups may also be present in polyheterosiloxane structures and may be bonded to first metal (M1) and Si, as determined using ²⁹Si and ¹³C NMR e.g. in an aromatic solvent. Residual counter ions from metal salts may also be present and may be bonded or chelated to first metal (M1) and second metal (M2).

The composition is typically soluble in an aromatic hydrocarbon solvent and may be soluble in other organic solvents as well. As used herein, “soluble” describes that the composition dissolves in, for example toluene, to form a homogeneous solution having a concentration of at least 1 weight percent of the composition at 23° C., alternatively having a concentration of at least 5 weight percent of the composition in toluene at 23° C., alternatively having a concentration of at least 10 weight percent of the composition in toluene at 23° C., alternatively having a concentration of at least 20 weight percent of the composition in toluene at 23° C. The composition may also be soluble in other organic solvents, such as chloroform, carbon tetrachloride, THF, and butyl acetate.

The composition typically has a weight average molecular weight (M_{w}) from 1,000 to 1,000,000 g/mole, from 2,000 to 400,000 g/mole, or from 2,000 to 200,000 g/mole. The molecular weight may be determined using modified GPC techniques to minimize possible interactions between the sample and the column system. For example, the molecular weight may be determined by GPC analysis using triple detectors (light scattering, refractometer, and viscometer) with a column (PL 5u 100a 100×7.8 mm) designed for rapid analysis or Flow Injection Polymer Analysis (FIPA).

The composition may include various heterosiloxane structures including, but not limited to, structures having Si—O—Si, Si—O-M1, M1-O-M1, and M1-O-M2 bonds as well as Si—O-M2 and M2-O-M2 bonds. Typically, a concentration of metal to metal bonds (e.g. M1-O-M1, M1-O-M2, M2-O-M2) is controlled so as to minimize formation of metal aggregates or particles of sufficient size to either render the composition insoluble in organic solvents or are of insufficient size to be detected using TEM techniques.

The composition may have “metal-rich” domains and “siloxane-rich” domains. As used herein the terminology “metal-rich” domains describes structural segments wherein a plurality of bonds include first metal (M1) or second metal (M2) (i.e., M1-O-M1, M1-O-M2, M2-O-M2, M1-O—Si, or M2-O—Si). As used herein, the terminology “siloxane-rich” describes structural segments wherein a plurality of bonds are siloxane (Si—O—Si) bonds. The “metal-rich” domains may be present such that the amount of metal to metal bonds (M1-O-M1, M1-O-M2, M2-O-M2) is minimized so as to minimize formation of metal aggregates or particles of sufficient size to minimize their solubility in aromatic hydrocarbons.

Alternatively, the metal rich domains may not be of sufficient size to be observed using high resolution transmission electron micrograph (TEM). Thus, in certain embodiments, the first metal (M1) and second metal (M2) metals are sufficiently distributed in the composition and have a domain size smaller than 10 nanometers, alternatively smaller than 5 nanometers, or alternatively smaller than 2 nanometers (detection limits for the TEM).

The composition is photoluminescent and may emit visible or ultraviolet light when exposed to, or excited by, visible or ultraviolet light. The composition exhibits a quantum yield of at least 0.05%, as determined using the formula described below. In various embodiments, the composition exhibits a quantum yield of at least 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 55, 60, 65, 70, 75, 80, %, or even greater. It is contemplated that the quantum yield may be alternatively described as any value, or range of values, both whole and fractional, within or between any one or more values described immediately above.

A limited size of the metal rich domains may lead to enhanced photoluminescence. For example, concentrations of lanthanide ions may exceed conventional concentration quenching thresholds without reduction in quantum yield. Photoluminescence may be assessed by measuring the absorption spectrum, the photoluminescent emission (PL) spectrum, or the photoluminescent excitation (PLE) spectrum of the composition. The absorption spectrum may be measured with standard spectrometers such as a Varian Carry 5000 spectrophotometer (Agilent Technologies, Palo Alto, Calif., USA). The PL excitation and emission spectra may be measured using a spectrofluorometer. A representative spectrofluorometer is the Fluorolog-2 spectrofluorometer (FL2) (HORIBA Jobin-Yvon Inc. Edison, N.J., USA).

A FL2 spectrofluorometer measures the photoluminescence of a material by illuminating a sample at a known wavelength, and measuring the emitted light with a photomultiplier tube. The sample is placed in a chamber between two independently controlled monochromators. A broadband light source is used with emission from a near UV, through the visible spectrum and into the near infrared. Typically this may be a xenon arc lamp. An absorption filter which blocks light below a target wavelength is disposed after the sample chamber, minimizing accidental measurement of the incident light as emitted light. In typical measurements, a 495 nm filter is used, but different filters may be used for different luminescent materials. For an emission scan, a first monochromator, disposed directly after a lamp, is tuned to an absorption band of the test sample. A second monochromator, disposed directly after the sample chamber, is scanned over a given range and the emitted light is measured by the photomultiplier tube, forming the photoluminescent emission (PL) spectrum. For the excitation spectrum, the second monochromator is set to a known emission band, and the first monochromator is scanned over a given range, measuring the photoluminescent excitation (PLE) spectrum. Measurements of the PLE may be normalized to the spectrum of the xenon lamp, which varies over its emission spectrum, for an accurate PLE spectrum.

The efficiency in which a photoluminescent material converts light from one wavelength to another can be described as quantum yield (QY). While it is possible to determine the QY of a material by comparing the absorption, PL and PLE spectra of a test composition to a reference composition, the QY may be measured more directly using a spectrometer coupled integration sphere, where the absorption and PL spectra of a composition are referenced against a blank reference sample. Representative equipment is an Ocean Optics USB4000 spectrometer fiber-optically coupled to an approximately 4 cm integration sphere, illuminated by a light emitting diode (LED) and run by Ocean Optics' Spectra Suite software (Ocean Optics, Dunedin, Fla., USA). This measures the absorption and emission of a sample under the illumination of an LED with a center wavelength of 395 nm The test sample is typically placed in the approximately 4 cm integration sphere in a glass vial with an absorption cut-off less than 350 nm. Incident light is typically measured by integrating the photon count in the range 350-450 nm, and emitted light in the range 480-850 nm. A different LED light source and/or photoluminescent material may require changing the integration ranges. The quantum yield, as a percentage, is typically calculated from the standard formula:

QY=[φ^{em}ₛₐₘₚ−φ^{em}_{ref})/(φ^{inc}_{ref}−φ^{inc}ₛₐₘₚ]×100

where φ is the number of photons measured by the 00 spectrometer in the range 350-450 nm with the superscript inc and 480-850 nm when the superscript em is used. The subscript samp indicates the measurement of luminescent sample, and the subscript ref indicates a measurement of an appropriate blank reference sample. For a typical measurement, the reference is the solvent that the composition is dissolved in for the sample measurement.

In a further embodiment, the composition emits visible and infrared light having a wavelength in the range of 400 to 1700 nm when excited by light having a wavelength of 200 to 1000 nm, where the emitted light is a longer wavelength than the excitation wavelength, with a photon quantum yield efficiency of at least 0.1%, where photon quantum yield is determined using the equation described above. Alternatively, the composition may emit visible light having a wavelength of 580 to 750 nm when excited by light having a wavelength of 250 to 550 nm. Alternatively, the composition may emit visible light having a wavelength of 610 to 620 nm when excited by ultraviolet light having a wavelength of 390 to 400 nm. The photon quantum yield efficiency (as determined using the above formula) may be at least 1%, alternatively 2%, alternatively 5%, alternatively 10%, alternatively 20%, alternatively 30%, alternatively 40%, alternatively 50%, or alternatively 60%.

In one embodiment, the composition emits visible light when excited by a UV light source. In another embodiment, the emitted light has a wavelength ranging from 450 to 750 nm and the excitation light source has a wavelength ranging from 250 to 520 nm. In still another embodiment, the composition emits visible light having a wavelength of 450 to 650 nm when excited by UV light. In an even further embodiment, the composition emits infrared light having a wavelength of 1450 to 1650 nm when excited by light having a wavelength from 650 to 5,000 nm. In still another embodiment, the composition emits near IR light having a wavelength of 1000 to 1100 nm when excited by light having a wavelength from 650 to 5,000 nm.

This disclosure also provides a silicone composition including the polyheterosiloxane composition and a silicone fluid. The silicone fluid is typically PDMS but is not limited in this way. In various embodiments, the silicone fluid has a viscosity at 25° C. of from about 0.001 to about 50 Pa·s, typically from about 0.02 to about 10 Pa·s, and more typically from about 0.05 to about 5 Pa·s. The silicone fluid can be linear, branched, cyclic, or a mixture thereof. Mixtures of the aforementioned fluids may also be used. Many of the linear, branched, and cyclic silicone fluids have melting points below about 25° C. Such materials are also commonly described as silicone liquids, silicone fluids, or silicone oils. A detailed description of silicone fluids can be found in many references, including “Chemistry and Technology of Silicones” by W. Knoll, Academic Press, 1968.

Non-limiting examples of linear silicone fluids suitable for use herein include trimethylsiloxy-terminated dimethylsiloxane fluids sold by Dow Corning Corporation under the trade name “Dow Corning® 200 Fluids”. These silicone fluids are manufactured to yield essentially linear oligomers and/or polymers typically having a viscosity of from 0.001 to about 50 Pa·s at 25° C. Such fluids are primarily linear but can include cyclic and/or branched structures. In one embodiment, the silicone fluid is a trimethylsiloxy-terminated polydimethylsiloxane having a viscosity of about 0.1 Pa·s at 25° C.

Additional non-limiting examples of suitable cyclic silicone fluids include the cyclic polydimethylsiloxanes sold by Dow Corning Corporation under the trade names “Dow Corning® 244, 245, 344, and 345 Fluids”, depending on the relative proportions of octamethylcyclotetrasiloxane and decamethylcyclopentasiloxane. Mixtures of the straight-chain and cyclic dimethyl may also be utilized. Even additional non-limiting examples of suitable silicone fluids are Me₃SiO[(OSiMe₃)₂SiO]SiMe₃ and Me₃SiO[(OSiMe₃)MeSiO]SiMe₃.

### Method of Forming the Composition:

This disclosure also provides a method of forming the composition. The method includes the step of reacting (A′) a metal (M3) alkoxide, (B′) an optional hydrolyzable metal (M4) salt, (C′) a silicon-containing material having hydrolyzable groups chosen from (C′1) an organosiloxane and (C′2) a silane, and (D) an amount of water that provides between 50 and 200% necessary to hydrolyze and condense hydrolyzable groups of (A′) and (C′) and optionally (B′). In the method, at least one of (M3) and (M4) is a lanthanide metal. The method may also include one or more steps as described in PCT application No. PCT/US 10/40510, which is expressly incorporated herein by reference.

It is to be understood that (A′), optionally (B′), (C′), and (D) may react together in any order. For example, (A′), optionally (B′), (C′), and (D) may react individually or with more of each other batch wise (e.g. simultaneously) and/or sequentially. One or more portions of (A′), optionally (B′), (C′), and (D) may react individually or with more of portions of each other batch wise (e.g. simultaneously) and/or sequentially. In one embodiment, (B′) is not utilized. In this embodiment, it is contemplated that alkoxides may be utilized in the absence of a hydrolyzable metal. In another embodiment, (B′) is utilized, e.g. with an alkoxide.

### (A′) Metal (M3) Alkoxide:

The (A′) metal (M3) alkoxide is not particularly limited and may be further defined as one or a mixture of alkoxides of one or more of the metals described above. One (A′) metal (M3) alkoxide, two different alkoxides of the same metal (M3), two alkoxides of different metals (M3), or a plurality of alkoxides of one or more metals (M3), may be utilized.

The metal (M3) is not particularly limited but is typically is the same as first metal (M1). In one embodiment, the metal (M3) is a lanthanide metal. In another embodiment, the metal (M3) is a non-lanthanide metal. The metal (M3) of the metal alkoxide may be the same as first metal (M1) or second metal (M2) or may be different. In addition, metal (M3) may be independently selected and may be any one of the aforementioned options for first metal (M1) and/or second metal (M2).

In one embodiment, the (A′) metal (M3) alkoxide has the general formula (I) R¹ₖM3Oₙ Xₚ(OR²)ᵥ₁₋ₖ₋ₚ₋₂ₙ. In Formula (I), subscript v1 is the oxidation state of metal (M3), typically from 1 to 7, 1 to 5, or 2 to 4. In Formula (I), subscript k is typically a value from 0 to 3, alternatively 0 to 2, and alternatively 0. In Formula (I), subscript n is typically a value from 0 to 2, alternatively 0 to 1, and alternatively 0. In Formula (I), subscript p is typically a value from 0 to 3, alternatively 0 to 2, and alternatively 0.

R¹ is typically a monovalent alkyl group having from 1 to 18 or from 1 to 8 carbon atoms. Examples of the alkyl group of R¹ include methyl, ethyl, propyl, isopropyl, butyl, t-butyl, hexyl, octyl, decyl, dodecyl, hexadecyl, and octadecyl groups.

In Formula (I), each R² is typically an independently selected monovalent alkyl group having from 1 to 6 carbon atoms, aryl group having from 6 to 8 carbon atoms, or a polyether group having a general formula (VI) —(R³O)ⱼR⁴, where j is a value from 1 to 4 and alternatively 1 to 2. Each R³ is typically an independently selected divalent alkylene group having from 2 to 6 carbon atoms. Each R⁴ is typically an independently selected hydrogen atom or monovalent alkyl group having from 1 to 6 carbon atoms. Examples of the alkyl groups of R² include methyl, ethyl, propyl, isopropyl, butyl, t-butyl, and hexyl groups. Examples of the aryl groups of R² include phenyl and benzyl. Examples of the divalent alkylene group having from 2 to 6 carbon atoms of R³ include —CH₂CH₂— and —CH₂CH(CH₃)—. Examples of the alkyl groups having from 1 to 6 carbon atoms of R⁴ are as described above for R². Examples of the polyether group of Formula (VI) include methoxyethyl, methoxypropyl, methoxybutyl, ethoxyethyl, ethoxypropyl, ethoxybutyl, methoxyethoxyethyl, and ethoxyethoxyethyl groups. Alternatively, R² is typically an alkyl group having from 1 to 6 carbon atoms e.g. a methyl, ethyl, propyl, and butyl group, or a propyl and butyl group.

In Formula (I), X is typically chosen from carboxylate ligands, organosulfonate ligands, organophosphate ligands, β-diketonate ligands, and chloride ligands, alternatively carboxylate ligands and β-diketonate ligands. The carboxylate ligands for X typically have a formula R¹⁵COO⁻ where R¹⁵ is chosen from hydrogen, alkyl groups, alkenyl groups, and aryl groups. Examples of alkyl groups for R¹⁵ include alkyl groups having from 1 to 18 carbon atoms, alternatively 1 to 8 carbon atoms as described above for R¹. Examples of alkenyl groups for R¹⁵ include alkenyl groups having from 2 to 18 carbon atoms, alternatively 2 to 8 carbon atoms such as vinyl, 2-propenyl, allyl, hexenyl, and octenyl groups. Examples of aryl groups for R¹⁵ include aryl groups having from 6 to 18 carbon atoms, alternatively 6 to 8 carbon atoms such as phenyl and benzyl groups. Alternatively, R¹⁵ is methyl, 2-propenyl, allyl, and phenyl. β-diketonate ligands for X can have the following structures:

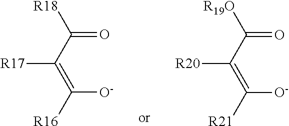

where R¹⁶, R¹⁸, and R²¹ are typically chosen from monovalent alkyl and aryl groups. Examples of alkyl groups for R¹⁶, R¹⁸, and R²¹ include alkyl groups having from 1 to 12 carbon atoms, alternatively 1 to 4 carbon atoms such as methyl, ethyl, trifluoromethyl, and t-butyl groups. Examples of aryl groups for R¹⁶, R¹⁸, and R²¹ include aryl groups having from 6 to 18 carbon atoms, alternatively 6 to 8 carbon atoms such as phenyl and tolyl groups. R¹⁹ is typically chosen from alkyl groups, alkenyl groups and aryl groups. Examples of alkyl groups for R¹⁹ include C1 to C18 alkyl groups, alternatively C1 to C8 alkyl groups such as methyl, ethyl, propyl, hexyl and octyl groups. Examples of alkenyl groups for R¹⁹ include alkenyl groups having from 2 to 18 carbon atoms, alternatively C2 to C8 carbon atoms such as allyl, hexenyl, and octenyl groups. Examples of aryl groups for R¹⁹ include aryl groups having from 6 to 18 carbon atoms, alternatively 6 to 8 carbon atoms such as phenyl and tolyl groups. R¹⁷ and R²⁰ are typically hydrogen or alkyl, alkenyl, and aryl groups. Examples of alkyl groups for R¹⁷ and R²⁰ include alkyl groups having from 1 to 12 carbon atoms, alternatively 1 to 8 carbon atoms such as methyl and ethyl groups. Examples of alkenyl groups for R¹⁷ and R²⁰ include alkenyl groups having from 2 to 18 carbon atoms, alternatively 2 to 8 carbon atoms such as vinyl, allyl, hexenyl, and octenyl groups. Examples of aryl groups for R¹⁷ and R²⁰ include aryl groups having from 6 to 18 carbon atoms, alternatively 6 to 8 carbon atoms such as phenyl and tolyl groups. R¹⁶, R¹⁷, R¹⁸, R¹⁹, R²⁰, and R²¹ are each independently selected and can be the same or different from each other.

Non-limiting examples of metal alkoxides described by Formula (I) include titanium tetrapropoxides, titanium tetrabutoxides, zirconium tetrapropoxides, and zirconium tetrabutoxides from DuPont, aluminum tripropoxides, aluminum tributoxides, aluminum phenoxide, antimony (III) ethoxide, barium isopropoxide, cadmium ethoxide, cadmium methoxide, cadmium methoxyethoxide, chromium (III) isopropoxide, copper (II) ethoxide, copper (II) methoxyethoxyethoxide, gallium ethoxide, gallium isopropoxide, diethyldiethoxygermane, ethyltriethoxygermane, methyltriethoxygermane, tetra-n-butoxygermane, hafnium ethoxide, hafnium 2-ethylhexoxide, hafnium 2-methoxymethyl-2-propoxide, indium methoxyethoxide, iron (III) ethoxide, magnesium ethoxide, magnesium methoxyethoxide, magnesium n-propoxide, molybdenum (V) ethoxide, niobium (V) n-butoxide, niobium (V) ethoxide, cerium (IV) t-butoxide, cerium (IV) isopropoxide, cerium (IV) ethylthioethoxide, cerium (IV) methoxyethoxide, strontium isopropoxide, strontium methoxypropoxide, tantalum (V) ethoxide, tantalum (V) methoxide, tantalum (V) isopropoxide, tantalum tetraethoxide diemthylaminoethoxide, di-n-butyldi-n-butoxytin, di-n-butyldimethoxytin, tetra-t-butoxytin, tri-n-butylethoxytin, titanium ethoxide, titanium 2-ethylhexoxide, titanium methoxide, titanium methoxypropoxide, titanium n-nonyloxide, tungsten (V) ethoxide, tungsten (VI) ethoxide, vanadium triisobutoxide oxide, vanadium triisopropoxide oxide, vanadium tri-n-propoxide oxide, vanadium oxide tris(methoxyethoxide), zinc methoxyethoxide, zirconium ethoxide, zirconium 2-ethylhexoxide, zirconium 2-methyl-2-butoxide, and zirconium 2-methoxymethyl-2-propoxide, aluminum s-butoxide bis(ethylaceto acetate), aluminum di-s-butoxide ethylacetoacetate, aluminum diisopropoxide ethylacetoacetate, aluminum 9-octdecenylacetoacetate diisopropoxide, tantalum (V) tetraethoxide pentanedionate, titanium allylacetoacetate triisopropoxide, titanium bis(triethanolamine) diisopropoxide, titanium chloride triisopropoxide, titanium dichloride diethoxide, titanium diisopropoxy bis(2,4-pentanedionate), titanium diisopropoxide bis(tetramethylheptanedionate), titanium diisopropoxide bis(ethylacetoacetate), titanium methacrylate triisopropoxide, titanium methacryloxyethylacetoacetate triisopropoxide, titanium trimethacrylate methoxyethoxyethoxide, titanium tris(dioctylphosphato)isopropoxide, titanium tris(dodecylbenzenesulfonate)isopropoxide, zirconium (bis-2,2′-(alloxymethyl)-butoxide)tris(dioctylphosphate), zirconium diisopropoxide bis(2,2,6,6-tetramethyl-3,5-heptanedionate), zirconium dimethacrylate dibutoxide, zirconium methacryloxyethylacetoacetate tri-n-propoxide, and combinations thereof. In one embodiment, (A′) is chosen from titanium tetraisopropoxide, titanium tetrabutoxide, zirconium tetrabutoxide, or aluminum sec-butoxide.

### Optional (B′) Hydrolyzable Metal (M4) Salt:

The optional (B′) hydrolyzable metal (M4) salt is not particularly limited and may be further defined as one or a mixture of salts of one or more of the metals described above. One ((B′) hydrolyzable metal (M4) salt, two different salts of the same metal (M4), two salts of different metals (M4), or a plurality of salts of one or more metals (M4), may be utilized.

Typically, the hydrolyzable metal (M4) is the same as the second metal (M2). In one embodiment, the hydrolyzable metal (M4) is a lanthanide metal. In another embodiment, the hydrolyzable metal (M4) is a non-lanthanide metal. The hydrolyzable metal (M4) may be the same as first metal (M1) or second metal (M2) or metal (M3) or may be different. In addition, hydrolyzable metal (M4) may be independently selected and may any one of the aforementioned options for first metal (M1) and/or second metal (M2) and/or metal (M3). However, at least one of metal (M3) and hydrolyzable metal (M4) is a lanthanide metal. For example, metal (M3) and hydrolyzable metal (M4) may be one of the following:

| (M3) | (M4) |
|---|---|
| Lanthanide Metal | Non-Lanthanide Metal |
| Combination of one or more | Non-Lanthanide Metal |
| Lanthanide Metals and one or | |
| more Non-Lanthanide Metals | |
| Non-Lanthanide Metal | Lanthanide Metal |
| Non-Lanthanide Metal | Combination of one or more |
| | Lanthanide Metals and one or |
| | more Non-Lanthanide Metals |
| Combination of one or more | Combination of one or more |
| Lanthanide Metals and one or | Lanthanide Metals and one or |
| more Non-Lanthanide Metals | more Non-Lanthanide Metals |

The optional (B′) hydrolyzable metal (M4) salt may be further described as (B′1) a non-hydrated metal salt having a general formula (IV) R⁷ₑM4(Z)_{(v2-e)/w} or (B′2) a hydrated metal salt having a general formula (V) M4(Z)_{v2/w}.xH₂O. v2 is the oxidation state of hydrolyzable metal (M4) and w is the oxidation state of ligand Z where Z is typically independently chosen from carboxylates, β-diketonates, fluoride, chloride, bromide, iodide, organic sulfonate, nitrate, nitrite, sulphate, sulfite, cyanide, phosphites, phosphates, organic phosphites, organic phosphates, and oxalate. Each R⁷ is typically an independently selected alkyl group having 1 to 18 carbon atoms, an alkenyl group having from 2 to 8 carbon atoms, or an aryl group having from 6 to 8 carbon atoms while e is typically a value from 0 to 3 and x is typically a value from 0 to 12, or from 0.5 to 12, and typically describes the average number of H₂O molecules associated with each metal salt molecule. The oxidation state of hydrolyzable metal (M4) may be as described above or may be different.

In Formulas (IV) and (V), subscript w is the oxidation state of ligand Z and typically can range from 1 to 3, alternatively from 1 to 2. The Z group in Formulas (IV) and (V) describes various counter ligands that may be attached to hydrolyzable metal (M4). Typically, each Z is independently chosen from carboxylate ligands, β-diketonate ligands, fluoride ligand, chloride ligand, bromide ligand, iodide ligand, organic sulfonate ligands, nitrate ligand, nitrite ligand, sulphate ligand, sulfite ligand, cyanide ligand, phosphate ligand, phosphite ligand, organic phosphite ligands, organic phosphate ligands, and oxalate ligand. In one embodiment, the carboxylate ligands and β-diketonate ligands for Z are as described above for X.

In various other embodiments, the carboxylate ligands may also be chosen from acrylate, methacrylate, butylenate, ethylhexanoate, undecanoate, undecylenate, dodecanoate, tridecanoate, pentadecanoate, hexadecanoate, heptadecanoate, octadecanoate, cis-9-octadecylenate (C18), cis-13-docoylsenoate (C22). In one embodiment, the carboxylate ligand is undecylenate or ethylhexanoate. In still other embodiments, the organic sulfonate ligands for Z have a formula R²²SO₃⁻, where R²² is chosen from monovalent alkyl groups, alkenyl groups and aryl groups. Examples of alkyl groups, alkenyl groups and aryl groups are as described above for R¹⁵. Alternatively R²² is tolyl, phenyl, or methyl.

The organic phosphate ligands for Z typically have a formula (R²³O)₂ PO₂⁻ or R²³O—PO₃²⁻, where R²³ is chosen from monovalent alkyl groups, alkenyl groups and aryl groups. Examples of alkyl groups, alkenyl groups and aryl groups are as described above for R¹⁵. Alternatively R²³ may be phenyl, butyl, or octyl.

In still other embodiments, organic phosphite ligands for Z typically have a formula (R²⁴O)₂ PO⁻ or R²⁴O—PO₂²⁻, where R²⁴ is chosen from monovalent alkyl groups, alkenyl groups and aryl groups. Examples of alkyl groups, alkenyl groups and aryl groups are as described above for R¹⁵. Alternatively R²⁴ may be phenyl, butyl, or octyl. Alternatively, Z in Formulas (IV) and (V) may be independently chosen from carboxylate ligands, β-diketonate ligands, nitrate ligands, sulphate ligands, and chloride ligands. Alternatively, Z may include carboxylate ligands and β-diketonate ligands.

In Formulas (IV) and (V), subscript e is typically a value from 0 to 3, alternatively from 0 to 2, and alternatively 0. In Formula (IV), R⁷ may be an independently selected alkyl group having 1 to 18 carbon atoms, an alkenyl group having from 2 to 8 carbon atoms, or an aryl group having from 6 to 8 carbon atoms. Examples of R⁷ are as described above for R⁵. In Formula (V), x may be a value from 0.5 to 12, and alternatively from 1 to 9.

Examples of (B′) hydrolyzable metal salts described by Formula (IV) include but are not limited to lanthanum acetate, cerium acetate, praseodymium acetate, neodymium acetate, promethium acetate, samarium acetate, europium acetate, gadolinium acetate, terbium acetate, dysprosium acetate, holmium acetate, erbium acetate, thulium acetate, ytterbium acetate, lutetium acetate, lanthanum acetylacetonate, cerium acetylacetonate, praseodymium acetylacetonate, neodymium acetylacetonate, promethium acetylacetonate, samarium acetylacetonate, europium acetylacetonate, gadolinium acetylacetonate, terbium acetylacetonate, dysprosium acetylacetonate, holmium acetylacetonate, erbium acetylacetonate, thulium acetylacetonate, ytterbium acetylacetonate, lutetium acetylacetonate, and combinations thereof. Examples of hydrated metal salts (B′2) described by Formula (VI) include the hydrated versions of any of the metal salts as described above for (B′1).

### (C′) Silicon-Containing Material:

(C′) is a silicon-containing material having hydrolyzable groups chosen from (C′1) an organosiloxane and (C′2) a silane. In one embodiment, (C′) is at least one silicon-containing material chosen from (C′1) an organosiloxane having an average formula (II) R⁵_{g}(R⁶O)_{f}SiO_{(4-(f+g))/2} or (C′2) a silane having a general formula (III) R⁵ₕSiZ′ᵢ. In another embodiment, Z′ is C1 or OR⁶, each R⁵ is an independently selected hydrogen atom, alkyl group having 1 to 18 carbon atoms, alkenyl group having from 2 to 18 carbon atoms, aryl group having from 6 to 12 carbon atoms, epoxy group, amino group, or carbinol group, providing at least one R⁵ groups of the (C′1) organosiloxane or (C′2) silane is an R¹ group, as described above for the R¹₂SiO_{2/2} or R¹SiO_{3/2} siloxy units. In other words, in one embodiment, at least one R⁵═R¹ in the (C′1) organosiloxane or (C′2) silane may be as described by formula (II) or (III). Each R⁶ is typically an independently selected hydrogen atom or alkyl group having from 1 to 6 carbon atoms, aryl group having from 6 to 8 carbon atoms, or a polyether group having a general formula (VI) —(R³O)ⱼR⁴, where j is a value from 1 to 4, each R³ is an independently selected divalent alkylene group having from 2 to 6 carbon atoms, R⁴ is an independently selected hydrogen atom or monovalent alkyl group having from 1 to 6 carbon atoms, the subscript f is a value from 0.1 to 3, g is a value from 0.5 to 3, and (f+g) is a value from 0.6 to 3.9, h is a value from 0 to 3, i is a value from 1 to 4 and (h+i) equals 4.

The alkyl groups having 1 to 18 carbon atoms of R⁵ in Formulas (II) and (III) are typically as described above for R¹. Alternatively, the alkyl group may include 1 to 6 carbon atoms and be, for example, a methyl, ethyl, propyl, butyl, or hexyl group.

The alkenyl groups having from 2 to 18 carbon atoms of R⁵ in Formulas (II) and (III) may be, for example, vinyl, propenyl, butenyl, pentenyl, hexenyl, or octenyl groups. Alternatively, the alkenyl group may include 2 to 8 carbon atoms and be, for example, a vinyl, allyl, or hexenyl group.

The aryl groups having 6 to 12 carbon atoms of R⁵ in Formulas (II) and (III) may be phenyl, naphthyl, benzyl, tolyl, xylyl, methylphenyl, 2-phenylethyl, 2-phenyl-2-methylethyl, chlorophenyl, bromophenyl and fluorophenyl groups. Alternatively, the aryl group may include 6 to 8 carbon atoms and be, for example, a phenyl group.

In Formula (II), subscript f may be a value from 0.1 to 3 and alternatively from 1 to 3. In Formula (II), subscript g may be a value from 0.5 to 3 and alternatively from 1.5 to 2.5. In Formula (II), subscripts (f+g) may have a value from 0.6 to 3.9 and alternatively from 1.5 to 3.

Examples of the organosiloxanes (C′1) described by Formula (II) include oligomeric and polymeric organosiloxanes, such as silanol-terminated polydimethylsiloxane, polymethylmethoxysiloxane, polysilsesquioxane, alkoxy and/or silanol including MQ resin, and combinations thereof. They may be made by hydrolysis of the corresponding organomethoxysilanes, organoethoxysilanes, organoisopropoxysilanes, and organochlorosilanes.

In Formula (III), each Z′ may be a chloro atom (Cl) or OR⁶, where R⁶ is as described above. Alternatively, Z′ may be OR⁶. In Formula (III), subscript h may be a value from 0 to 3, from 1 to 3, or from 2 to 3. In Formula (III), subscript i is a value from 1 to 4, from 1 to 3, or from 1 to 2. In Formula (III), subscripts (h+i) may equal 4.

Examples of the silanes (C′2) described by Formula (III) include methyltrichlorosilane, phenyltrichlorosilane, dimethyldichlorosilane, phenylmethyldichlorosilane, methyltrimethoxysilane, phenyltrimethoxysilane, dimethyldimethoxysilane, phenylmethyldimethoxysilane, phenylsilanetriol, diphenylsilanediol, phenylmethylsilanediol, dimethylsilanediol, trimethylsilanol, triphenylsilanol, phenyldimethoxysilanol, phenylmethoxysilanediol, methyldimethoxysilanol, methylmethoxysilanediol, phenyldiethoxysilanol, phenylethoxysilanediol, methyldiethoxysilanol, methylethoxysilanediol.

In one embodiment of the present method, (A′) and (B′) are reacted with water to form a mixed metal oxide solution including metal (M3)-O— (M4) oxo-bonds. The method may include further reacting the mixed metal oxides solution with (C′1) or (C′2) to form the composition, wherein the total amount of water added is between 50 and 200% of the amount theoretically necessary for the hydrolysis and condensation of all alkoxy groups and other hydrolyzable groups on (A′), (B′), and (C′). The percent may be further described as mole or weight percent as a theoretical calculated stoichiometric amount.

### (D) Water:

Typically, an amount of (D) water is utilized (and/or reacted) with (A′), optionally (B′), and/or (C′) so that polyheterosiloxanes having at least two non-Si metal elements can be formed. Since water can also be incorporated via the hydrated metal salts (B′2), hydrated metal salts may be utilized such that no liquid water may be utilized and the water originates from the hydrated metal salts. 0.5 mole of water may be used for hydrolysis and condensation of 1 mole of alkoxy and other hydrolyzable groups. Alternatively, the amount of water utilized to make the present polyheterosiloxanes typically may be from 50 to 200%, 70% to 150%, from 100% to 150%, or from 80% to 120%, of the theoretical amount of water necessary for complete hydrolysis and condensation of alkoxy and other hydrolyzable groups, as first described above. Typically, the water is added slowly to (A′), optionally (B′), and/or (C′) in an attempt to ensure that the metal alkoxide does not react quickly with the water so as to form a precipitate. Alternatively, the water may be diluted with one or more solvents, such as those described above. Depending on the solvents used and when they are added, the water may also be added at one time or during one or more of the method steps. Other hydrolyzable groups that may be present and need to be hydrolyzed and condensed are any found on the components used, including, but not limited to, chloro.

Each of the components (A′), optionally (B′), and/or (C′) may be liquid or solid and it is typical that they are pre-mixed or dispersed. Stirring one or more of the components (A′), optionally (B′), and/or (C′) in a solvent may provide way to obtain a homogenous dispersion. As used herein, the terminology “dispersion” describes that the molecules of the various components (A′), optionally (B′), and/or (C′) are homogenously distributed. A solvent may not be needed if one or more components (A′), optionally (B′), and/or (C′) can be dispersed in one or more of each other. Such solvents may be as described and may be polar solvents, non-polar solvents, hydrocarbon solvents including aromatic and saturated hydrocarbons, alcohols, etc. Non-limiting examples of suitable solvents include hydrocarbonethanol, 1-propanol, isopropanol, 1-butanol, 2-butanol, methoxyethanol, methoxyethoxyethanol, butyl acetate, toluene, and xylene, alternatively isopropanol, 1-butanol, 2-butanol, and butyl acetate. The dispersing or mixing may be completed by any conventional means such as stirring.

Typically, reaction of (A′), optionally (B′), and/or (C′) with (D) water proceeds at room temperature (e.g. 20-30° C.) but if desired, elevated temperatures up to about 140° C. may be used. Alternatively, the temperature can range from 20° C. to 120° C. Typically, the reaction may last 30 minutes to 24 hours and alternatively from 10 minutes to 4 hours.

An optional method steps includes removing the solvent to form the composition. The solvent can be removed by any conventional manner such as heating to elevated temperatures or using reduced pressure. The composition can then be redispersed in a solvent of choice such as toluene, THF, butyl acetate, chloroform, dioxane, 1-butanol, and pyridine. Since the Si—O-M may be susceptible to hydrolytic cleavage in the presence of water, to maximize shelf life it is typical to minimize the exposure of the composition to moisture.

In various embodiments, a non-lanthanide metal (e.g. Ti, Al, Zr) is present in the composition is amounts of from 0.01 to 0.8 mol/mol. A lanthanide metal (e.g. Eu, Tb, Sm) may be present in amounts of from 0.001 to 0.5 mol/mol. Additional metals (e.g. Zn, Al, Y, Ag, Mn,) may be present in amounts of from 0.0001 to 0.4 mol/mol. During synthesis, a concentration of resin components in solvent may be from 1 and 50 wt %. The synthesis temperature may be from ice-water (0° C.) up to the refluxing temperature of the solution utilized (e.g. about 100-120° C.). In various additional embodiments, the solvent may be further defined as toluene and/or any alcohol such as ethanol, IPA, butanol, etc. Some ether solvents can also be used, such as butyl acetate or acetyl acetate. In still other embodiments, one or more of (M1)-(M4) may be further defined as titanium (alkoxide), erbium acetate or benzoate, and/or zinc acetate or benzoate. It is also contemplated that, via the method, M3 may be converted to M1 and M4 may be converted to M2.

### EXAMPLES

The following examples are included to demonstrate various embodiments of the disclosure and are not limiting. All percentages are in weight % unless indicated otherwise. All measurements are conducted at 23° C. unless indicated otherwise.

### Test Methods:

### ²⁹Si Nuclear Magnetic Resonance Spectroscopy (NMR)

Samples for NMR analysis are prepared by introducing approximately 2 grams of sample into a vial and diluting with approximately 6 grams of 0.04M Cr(acac)₃ solution in CDCl₃. Samples are mixed and transferred into a silicon-free NMR tube. Spectra are acquired using a 400 MHz NMR.

### Photoluminescence

Photoluminescence of the examples is measured using a Fluorolog-2 spectrofluorometer, manufactured by Jobin Yvon SPEX, and an Ocean Optics USB4000 spectrometer fiber coupled to an integrating sphere and using Ocean Optics' Spectra Suite software. The specific parameters are as described above.

### Transmission Electron Microscopy (TEM)

TEM images are obtained using a JEOL 2100F TEM. Sample morphology is observed at 200 KeV under bright field TEM mode using a high contrast objective aperture to enhance the image contrast. Digital images are taken using a Gatan CCD camera attached under the TEM column with Digital Micrograph software. The sample solution is diluted to 1 to 2% solution and dropped onto a carbon film coated Cu TEM grid, and air-dried.

### Example 1

### Si+Ti+Eu

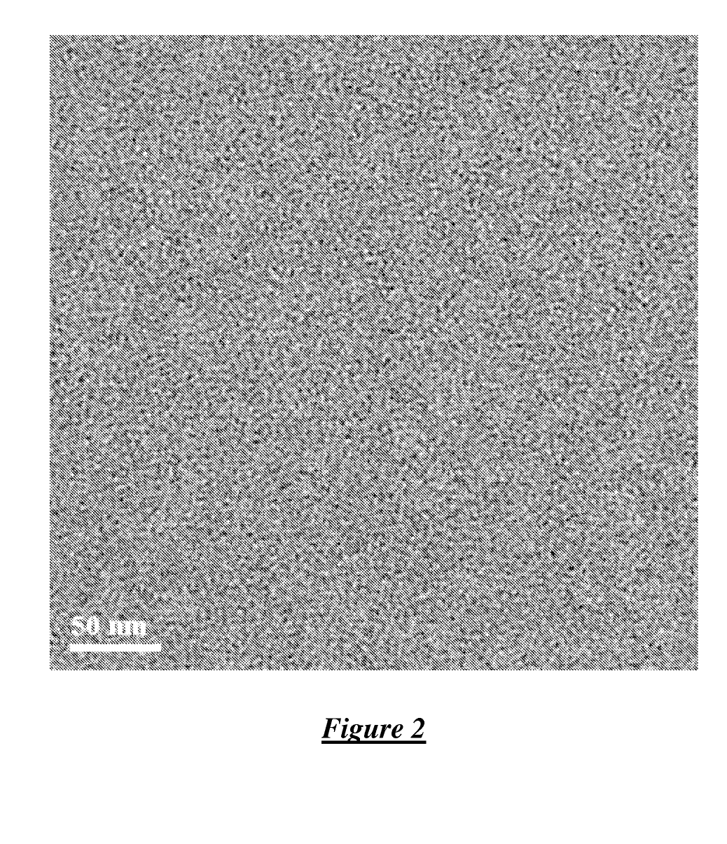

1.50 g europium acetate hydrate, 21.3 g titanium tetraisopropoxide, and 18.9 g of IPA are charged into a 500 mL 3-neck flask and stirred at RT for 30 minutes. 1.26 g H₂O (4% in IPA) is added to the flask slowly. The reaction stirs for another 30 minutes. A pre-hydrolyzed siloxane solution is prepared by mixing 6.22 g phenylmethyldimethoxysilane, 2.50 g phenyltrimethoxysilane, 12.5 g toluene and 2.34 g 0.1N HCl and sonicating the combination for a total of 15 minutes. 37.5 g of toluene is added to the europium/titanium reaction combination immediately followed by the pre-hydrolyzed siloxane solution. A total amount of H₂O is ˜106%. Stirring is continued for 4 hours. Solvents are removed using a rotary evaporator at 57° C. and 5 mm Hg. The product is a white solid with a composition of Ti_{0.6}Eu_{0.03}D^{PhMe}_{0.27}T^{Ph}_{0.1}, soluble in many organic solvents such as toluene, THF, and chloroform. The product shows red luminance with blue and near UV excitation, with a peak emission wavelength of about 615 nm and a peak excitation wavelength of about 395 nm In a 20 wt % solution in toluene the product shows approximately 11% quantum yield (QY). A TEM image of a representative sample of this example is shown in FIG. 2. The TEM does not show any detectable particles at this resolution. The white spots represent signal noise.

### Example 2

### Si+Ti+Yb

6.43 g ytterbium acetate tetrahydrate, 67.8 g titanium tetraisopropoxide, and 45 g IPA are charged into a 500 ml 3-neck flask and stirred at RT for 30 minutes. 4.02 g H₂O (4% in IPA) is added into the flask slowly. 84 g toluene is then added and stirred at RT for 60 minutes. A prehydrolyzed siloxane solution is prepared by mixing 30.7 g phenylmethyldimethoxysilane, 25 g toluene, and 7.32 g 0.01M HCl and sonicating the combination for 5 minutes. The prehydrolyzed siloxane solution is added to the flask quickly. A total amount of H₂O is ˜100%. Stirring is continued at RT for 3 hours. Solvents are removed using a rotary evaporator at 60° C. and 5 mm Hg. The product is a white solid with a composition of Yb_{0.03}Ti_{0.57}D^{PhMe}_{0.40}, soluble in many organic solvents, such as butyl acetate, toluene, THF, and chloroform.

### Example 3

### Si+Ti+Nd

4.37 g neodymium acetate hydrate, 59.8 g titanium tetraisopropoxide, and 40 g IPA are charged into a 1 L3-neck flask and stirred at RT for 30 minutes. 4.35 g H₂O (4.5% in IPA) is added into the flask slowly. 10 g IPA is then added and stirred at RT for 60 minutes. A prehydrolyzed siloxane solution is prepared by mixing 26.88 g phenylmethyldimethoxysilane, 43 g toluene, and 6.43 g 0.01M HCl and sonicating the combination for 15 minutes. The prehydrolyzed siloxane solution is added to the flask quickly. A total amount of H₂O is ˜100%. 113 g toluene is then added and stirring is continued at RT for 3 hours. 300 g solvents is distilled off and residual solvents are removed using a rotary evaporator at 60° C. and 5 mm Hg. The product is a purple solid with a composition of Nd_{0.03}Ti_{0.57}D^{PhMe}_{0.40}, soluble in many organic solvents, such as butyl acetate, toluene, THF, and chloroform.

### Example 4

### Si+Ti+Dy

4.75 dysprosium acetate tetrahydrate, 62.4 g titanium tetraisopropoxide, and 41.0 IPA are charged into a 1 L 3-neck flask and stirred at RT for 30 minutes. 4.00 g H₂O (4% in IPA) is added into the flask slowly. Then added 65 g toluene and stirred at RT for 60 minutes. A prehydrolyzed siloxane solution is prepared by mixing 28.2 g phenylmethyldimethoxysilane, 55 g toluene, 10 g IPA, and 6.72 g 0.01M HCl and sonicating the combination for 15 minutes. The prehydrolyzed siloxane solution is added to the flask quickly. A total amount of H₂O is ˜100%. Stirring is continued at RT for 3.5 hours. Solvents are removed using a rotary evaporator at 60° C. and 5 mm Hg. The product is a white solid with a composition of Dy_{0.03}Ti_{0.57}D^{PhMe}_{0.40}, soluble in many organic solvents, such as butyl acetate, toluene, THF, and chloroform. The product shows yellow luminance with blue and near UV excitation, with a peak emission wavelength of about 595 nm and a peak excitation wavelength of about 390 nm.

### Example 5

### Si+Ti+Sm

5.33 g samarium acetate hydrate, 72.0 g titanium tetraisopropoxide, and 47.6 g IPA are charged into a 1 L 3-neck flask and stirred at RT for 30 minutes. 4.55 g H₂O (4% in IPA) is added into the flask slowly. Then 132 g toluene is added and stirred at RT for 60 minutes. A prehydrolyzed siloxane solution is prepared by mixing 28.83 g phenylmethyldimethoxysilane, 4.12 g phenyltrimethoxysilane, 25 g toluene, and 8.0 g 0.01M HCl and sonicating the combination for 15 minutes. The prehydrolyzed siloxane solution is added to the flask quickly. A total amount of H₂O is ˜100%. Stirring is continued at RT for 4 hours. Solvents are removed using a rotary evaporator at 60° C. and 5 mm Hg. The product is a white solid with a composition of Sm_{0.03}Ti_{0.57}D^{PhMe}_{0.35}T^{Ph}_{0.05}, soluble in many organic solvents, such as butyl acetate, toluene, THF, and chloroform. The product shows yellow luminance with blue and near UV excitation, with a peak emission wavelengths of about 570 nm, 600 nm and 650 nm, and a peak excitation wavelength of about 400 nm. In a 20 wt % solution in toluene the product shows approximately 0.2% quantum yield (QY).

### Example 6

### Si+Ti+Tb

5.53 g terbium acetate hydrate, 73.2 g titanium tetraisopropoxide, 32 g toluene, and 41.0 IPA are charged into a 1 L 3-neck flask and stirred at RT for 30 minutes. 4.65 g H₂O (4% in IPA) is added into the flask slowly. Then 69 g toluene is added and stirred at RT for 60 minutes. A prehydrolyzed siloxane solution is prepared by mixing 32.85 g phenylmethyldimethoxysilane, 25 g toluene, and 7.90 g 0.01M HCl and sonicating the combination for 15 minutes. The prehydrolyzed siloxane solution is added to the flask quickly. A total amount of H₂O is ˜100%. Stirring is continued at RT for 3.5 hours. Solvents are removed using a rotary evaporator at 60° C. and 5 mm Hg. The product is a white solid with a composition of Tb_{0.03}Ti_{0.57}D^{PhMe}_{0.40}, soluble in many organic solvents, such as butyl acetate, toluene, THF, and chloroform. The product shows green luminance with blue and near UV excitation, with a peak emission wavelength of about 545 nm and a peak excitation wavelength of about 485 nm In a 20 wt % solution in toluene the product shows approximately 0.1% quantum yield (QY).

### Example 7

### Si+Ti+Er

1.25 g erbium acetate hydrate, 17.05 g titanium tetraisopropoxide, 30 g toluene, and 15.2 g IPA are charged into a 250 ml 3-neck flask and stirred at RT for 30 minutes. 1.00 g H₂O (4% in IPA) is added into the flask slowly. A prehydrolyzed siloxane solution is prepared by mixing 4.92 g phenylmethyldimethoxysilane, 1.98 g phenyltrimethoxysilane, 10.0 g toluene, and 1.81 g 0.1M HCl and sonicating the combination for 15 minutes. The prehydrolyzed siloxane solution is added to the flask quickly. A total amount of H₂O is ˜110%. Stirring is continued at RT for 4 hours. Solvents are removed using a rotary evaporator at 60° C. and 5 mm Hg. The product is a pink solid with a composition of Er_{0.03}Ti_{0.60}D^{PhMe}_{0.27}T^{Ph}_{0.10}, soluble in many organic solvents, such as butyl acetate, toluene, THF, and chloroform.

### Example 8

### Si+Zr+Eu

4.36 g europium acetate hydrate, 24.2 g NBZ solution (80% zirconium tetrabutoxide+20% 1-butanol), and 40 g toluene are charged into a 250 ml 3-neck flask and refluxed at 107° C. for 80 minutes. A prehydrolyzed siloxane solution is prepared by mixing 7.75 g phenylmethyldimethoxysilane, 2.82 g phenyltrimethoxysilane, 10 g toluene, and 1.80 g 0.01M HCl and sonicating the combination for 20 minutes. The prehydrolyzed siloxane solution is added to the flask and the solution temperature dropped to 97° C. After 10 minutes a solution including 0.74 g H₂O, 12.0 g toluene, and 3.0 g IPA is added. A total amount of H₂O is ˜100%. The solution is maintained at ˜90° C. for 30 minutes. Solvent is removed using a rotary evaporator at 70° C. and 5 mm Hg. The product is a white solid with a composition of Eu_{0.10}Zr_{0.42}D^{PhMe}_{0.36} T^{Ph}_{0.12}, soluble in many organic solvents, such as butyl acetate, toluene, THF, and chloroform.

### Example 9

### Si+Al+Eu

31.1 g aluminum sec-butoxide stock solution (2.50 mmol/g in 2-butanol), 15.0 g 2-butanol, and 50.0 g toluene are mixed in a 250 ml 3-neck flask. Under stirring, 9.0 g 39% Ph₂MeSiOH heptane solution is added into the flask. The clear solution is stirred at RT for 30 minutes. 5.85 g europium acetate hydrate is added to the flask and the solution is heated to 90° C. for 100 minutes to form a clear yellow solution. A prehydrolyzed siloxane solution is prepared by mixing 6.75 g phenylmethyldimethoxysilane, 1.99 g phenyltrimethoxysilane, and 1.88 g 0.01M HCl and sonicating the combination for 20 minutes. The prehydrolyzed siloxane solution is added to the flask and the solution turns colorless quickly. After 10 minutes, 0.34 g H₂O (10% in 2-butanol) is added to the flask. A total amount of H₂O is ˜100%. Stirring is continued at 90° C. for 2 hours. 75 g solvent is distilled off and the solution is cooled to ˜70° C. Solvent residue is removed using a rotary evaporator at 70° C. and mm Hg. The product is a white solid with a composition of Eu_{0.10}Al_{0.40}M^{Ph2Me}_{0.10}D^{PhMe}_{0.24}T^{Ph}_{0.06}, soluble in many organic solvents, such as butyl acetate, toluene, THF, and chloroform. The product shows orange or red luminance with blue and near UV excitation, with a peak emission wavelength of about 615 nm and a peak excitation wavelength of about 395 nm.

### Example 10

### Si+Ti+Eu

3.72 g europium ethylhexanoate, 5.12 g titanium tetraisopropoxide, 15 g IPA, 45 g toluene, and 0.32 g 0.1N HCl solution are charged into a 500 mL 3-neck flask and refluxed at 90° C. for 1 hour. A prehydrolyzed siloxane solution is prepared by mixing 6.80 g octyltrimethoxysilane, 13.70 g dimethylvinylsiloxy and trimethoxysiloxy-terminated dimethyl siloxane, 25 g toluene, 25 g IPA, 1.65 g 0.1N HCl solution, and sonicating the combination for a total of 30 minutes. After the addition of the prehydrolyzed siloxane solution, the solution is refluxed at 80° C. for 2 hours. A total amount of H₂O is ˜100%. Solvents are removed using a rotary evaporator at 80° C. and 5 mm Hg. The product is a clear vicious liquid with about 4 wt % of Eu. The product is soluble in many organic solvents such as toluene, THF, and chloroform and is immiscible with PDMS. The product shows red luminance with blue and near UV excitation, with a peak emission wavelength of about 615 nm and a peak excitation wavelength of about 395 nm In a 20 wt % solution in toluene the product shows approximately 11% quantum yield (QY).

### Example 11

### Si+Zr+Eu

5.07 g europium acetate hydrate, 17.65 g NBZ solution (80% zirconium tetrabutoxide+20% 1-butanol), and 40 g toluene are charged into a 250 ml 3-neck flask and refluxed at 107° C. for 80 minutes. A prehydrolyzed siloxane solution is prepared by mixing 2.99 g phenylmethyldimethoxysilane, 1.80 g phenyltrimethoxysilane, 10 g toluene, 4 g butanol, and 0.86 g 0.1N HCl and sonicating the combination for 30 minutes. The prehydrolyzed siloxane solution is added to the flask and the solution is continued refluxing for 30 minutes. Then a solution including 0.66 g H₂O and 13 g butanol is added into the flask. A total amount of H₂O is ˜100%. The solution is maintained at refluxing temperature for 30 minutes. Solvent is removed using a rotary evaporator at 85° C. and 5 mm Hg. The product is a white solid with a composition of Eu_{0.20}Zr_{0.50}D^{PhMe}_{0.225}T^{Ph}_{0.075}, soluble in many organic solvents, such as butyl acetate, toluene, THF, and chloroform. In a 10 wt % solution in butyl acetate the product shows approximately 31% quantum yield (QY).

### Example 12

### Si+Ti+Eu

1.407 g of europium undecylenate hydrate (prepared by the experimental procedure disclosed in Eur. J. Inorg. Chem. 2000, 1429-1436 for the synthesis of lanthanide dodecanoates), 2.737 g of titanium n-butoxide, and 4 g of 1-propanol are charged into a 125 mL Erlenmeyer flask equipped with reflux condenser and stirs at 60-70° C. until all compounds dissolve. 0.145 g of water dissolved in 1 g of 1-propanol is added and the solution stirs for 30 min. A pre-hydrolyzed siloxane solution is prepared by mixing 1.373 g of phenylmethyldimethoxysilane, 0.494 g of phenyltrimethoxysilane, 5 g toluene and 0.377 g 0.1N HCl and stirring the combination rapidly for a total of 5 min The pre-hydrolyzed siloxane solution is added and the solution stirs at 60° C. for 4 hours. A total amount of H₂O is ˜110%. Solvents are removed first using a rotary evaporation at 80° C. and 15 mm Hg, then using high vacuum at 0.05 mm Hg and 80° C. The product is a yellow-orange viscous liquid with a composition of Ti_{0.4}Eu_{0.1}D^{PhMe}_{0.375}T^{Ph}_{0.125}, soluble in many organic solvents such as toluene, THF, and chloroform. This product exhibits orange or red luminance with blue and near UV excitation, with a peak emission wavelength of 615 nm and a peak excitation wavelength of 395 nm In a 20 wt % solution in toluene the product had a 13.6% quantum yield.

### Example 13

### Si+Ti+Eu

1.409 g of europium undecylenate hydrate (prepared by the experimental procedure disclosed in Eur. J. Inorg. Chem. 2000, 1429-1436 for the synthesis of lanthanide dodecanoates) 2.733 g of titanium n-butoxide, and 4 g of 1-propanol are charged into a 125 mL Erlenmeyer flask equipped with reflux condenser and stirs at 60-70° C. until all compounds dissolved. 0.145 g of water dissolved in 1 g of 1-propanol is added and the solution stirs for 30 min. A pre-hydrolyzed siloxane solution is prepared by mixing 0.908 g of dimethyldimethoxysilane, 0.350 g methyltrimethoxysilane, 5 g toluene and 0.380 g 0.1N HCl and stirring the combination rapidly for a total of 5 min The pre-hydrolyzed siloxane solution is added and the solution stirs at 60° C. for 4 hours. A total amount of H₂O is ˜110%. Solvents are removed first using a rotary evaporation at 80° C. and 15 mm Hg, then using high vacuum at 0.05 mm Hg and 80° C. The product is a yellow-orange viscous liquid with a composition of Ti_{0.4}Eu_{0.1}D^{Me2}_{0.375}T^{Me}_{0.125}, soluble in many organic solvents such as toluene, THF, and chloroform. The product exhibits orange or red luminance with blue and near UV excitation, with a peak emission wavelength of 615 nm and a peak excitation wavelength of 395 nm In a 20 wt % solution in toluene the product had a 10.4% quantum yield.

### Example 14

### Si+Ti+Eu

1.407 g of europium undecylenate hydrate (prepared by the experimental procedure disclosed in Eur. J. Inorg. Chem. 2000, 1429-1436 for the synthesis of lanthanide dodecanoates) 2.723 g of titanium n-butoxide, and 4 g of 1-propanol are charged into a 125 mL Erlenmeyer flask equipped with reflux condenser and stirs at 60-70° C. until all compounds dissolve. 0.144 g of water dissolved in 1 g of 1-propanol is added and the solution stirs for 30 min. A pre-hydrolyzed siloxane solution is prepared by mixing 6.115 g of a silanol terminated polymethylphenylsiloxane having an average of 5 (CH₃)(C₆H₅)SiO_{2/2} units (abbreviated as D^{PhMe}), 0.499 g phenyltrimethoxysilane, 5 g toluene and 0.079 g 0.1N HCl and the combination stirs rapidly for a total of 5 min The pre-hydrolyzed siloxane solution is added and the solution stirs at 60° C. for 4 hours. A total amount of H₂O is ˜110%. Solvents are removed first using a rotary evaporation at 80° C. and 15 mm Hg, then using high vacuum at 0.05 mm Hg and 80° C. The product is a yellow-orange viscous liquid with a composition of Ti_{0.4}Eu_{0.1}D^{PhMe}_{0.375}T^{Me}_{0.125}, soluble in many organic solvents such as toluene, THF, and chloroform. The product exhibits orange or red luminance with blue and near UV excitation, with a peak emission wavelength of 615 nm and a peak excitation wavelength of 395 nm. In a 20 wt % solution in toluene the product had a 13.2% quantum yield.

### Example 15

### Si+Ti+Eu

1.400 g of europium undecylenate hydrate (prepared by the experimental procedure disclosed in Eur. J. Inorg. Chem. 2000, 1429-1436 for the synthesis of lanthanide dodecanoates), 2.719 g of titanium n-butoxide, and 4 g of 1-propanol are charged into a 125 mL Erlenmeyer flask equipped with reflux condenser and stirs at 60-70° C. until all compounds dissolved. 0.144 g of water dissolved in 1 g of 1-propanol is added and the solution stirs for 30 min. A pre-hydrolyzed siloxane solution is prepared by mixing 4.121 g of silanol terminated polydimethylsiloxane having an average of 18 (CH₃)₂SiO_{2/2} units, 0.431 g of methyltrimethoxysilane, 5 g toluene and 0.098 g 0.1N HCl and the combination stirs rapidly for a total of 5 min The pre-hydrolyzed siloxane solution is added and the solution stirs at 60° C. for 4 hours. A total amount of H₂O iₛ ˜110%. Solvents are removed first using a rotary evaporation at 80° C. and 15 mm Hg, then using high vacuum at 0.05 mm Hg and 80° C. The product is a yellow-orange viscous liquid with a composition of Ti_{0.4}Eu_{0.1}D^{Me2}_{0.375}T^{Ph}_{0.125}, soluble in many organic solvents such as toluene, THF, and chloroform. The product exhibits orange or red luminance with blue and near UV excitation, with a peak emission wavelength of 615 nm and a peak excitation wavelength of 395 nm In a 20 wt % solution in toluene the product had a 11.0% quantum yield.

### Examples 16-32

A variety of additional compositions are synthesized using similar synthetic procedures as described above. For Examples 16-32 below, the lanthanide ion luminance center is Eu, with red/orange luminance with blue and UV excitation. The peak emission wavelength is approximately 615 nm, and the peak excitation wavelength is approximately 395 nm.

TABLE 1

| | | | | H₂O | Quantum |
|---|---|---|---|---|---|
| Ex. | (M3) | (M4) | Composition | (%) | Yield (%) |
| 16 | Ti(OPr)₄ | EuAc₃•xH₂O | Ti_{0.6}Eu_{0.03}D^{PhMe}_{0.27}T^{Ph}_{0.1} | 104 | 9.2 |
| 17 | Ti(OPr)₄ | EuAc₃•xH₂O | Ti_{0.6}Eu_{0.06}D^{PhMe}_{0.25}T^{Ph}_{0.09} | 104 | 17.7 |
| 18 | Ti(OPr)₄ | EuAc₃•xH₂O | Ti_{0.6}Eu_{0.1}D^{PhMe}_{0.22}T^{Ph}_{0.081} | 104 | 23.9 |
| 19 | Ti(OBu)₄ | EuAc₃•xH₂O | Ti_{0.6}Eu_{0.03}D^{Me2}_{0.27}T^{Me}_{0.1} | 104 | 7.8 |
| 20 | Ti(OBu)₄ | EuAc₃•xH₂O | Ti_{0.6}Eu_{0.1}D^{PhMe}_{0.22}T^{Ph}_{0.081} | 104 | 13.5 |
| 21 | Ti(OBu)₄ | EuAc₃•xH₂O | Ti_{0.6}Eu_{0.15}D^{PhMe}_{0.184}T^{Ph}_{0.068} | 104 | 16.9 |
| 22 | Ti(OPr)₄ | EuAc₃•xH₂O | Ti_{0.6}Eu_{0.03}D^{PhMe}_{0.37} | 104 | 13.9 |
| 23 | Ti(OPr)₄ | EuAc₃•xH₂O | Ti_{0.6}Eu_{0.03}D^{PhMe}_{0.185}T^{Ph}_{0.185} | 104 | 17.7 |
| 24 | Ti(OBu)₄ | EuAc₃•xH₂O | Ti_{0.6}Eu_{0.1}D^{PhMe}_{0.3} | 104 | 19.3 |
| 25 | Ti(OBu)₄ | EuAc₃•xH₂O | Ti_{0.6}Eu_{0.2}D^{PhMe}_{0.15}T^{Ph}_{0.05} | 104 | 43.9 |
| 26 | Ti(OBu)₄ | EuAc₃•xH₂O | Ti_{0.6}Eu_{0.2}D^{PhMe}_{0.15}T^{Ph}_{0.05} | 104 | 40.4 |
| 27 | Ti(OBu)₄ | EuAc₃•xH₂O | Ti_{0.6}Eu_{0.1}T^{Ph}_{0.3} | 104 | 22.2 |
| 28 | Ti(OBu)₄ | EuAc₃•xH₂O | Ti_{0.6}Eu_{0.03}T^{Ph}_{0.37} | 104 | 10.03 |
| 29 | Ti(OBu)₄ | EuAc₃•xH₂O | Ti_{0.6}Eu_{0.1}D^{PhMe}_{0.151}T^{Ph}_{0.151} | 104 | 26.5 |
| 30 | Al(O^{s}Bu)₃ | EuAc₃•xH₂O | Eu_{0.02}Al_{0.37}M^{Ph2Me}_{0.07}D^{PhMe}_{0.40}T^{Ph}_{0.14} | 100 | 10.9 |
| 31 | Al(O^{s}Bu)₃ | EuAc₃•xH₂O | Eu_{0.05}Al_{0.40}M^{Ph2Me}_{0.05}D^{PhMe}_{0.40}T^{Ph}_{0.10} | 100 | 28.0 |
| 32 | Zr(OBu)₄ | EuAc₃•xH₂O | Zr_{0.5}Eu_{0.15}D^{PhMe}_{0.26}T^{Ph}_{0.09} | 100 | 17.5 |

### Example 33

### Si+Ti+Zn+Eu

3.50 g europium acetate hydrate, 1.73 g zinc acetate hydrate, 16.2 g titanium n-butoxide, and 20 g of toluene are charged into a 500 mL 3-neck flask and stirred at 60° C. for 30 minutes. A pre-hydrolyzed siloxane solution is prepared by mixing 3.45 g phenylmethyldimethoxysilane, 1.89 g phenyltrimethoxysilane, 15 g toluene and 1.85 g 0.1N HCl and sonicating the mixture for a total of 30 minutes. The solution is stirred at 60° C. for 4 hours after the addition of pre-hydrolyzed siloxane solution. A total amount of H₂O is ˜110%. Solvents are removed using a rotary evaporation at 80° C. and 5 mm Hg. The product is a white solid with a composition of Ti_{0.5}Zn_{0.1}Eu_{0.1}D^{PhMe}_{0.2}T^{Ph}_{0.1}, soluble in many organic solvents such as toluene, THF, and chloroform. The product shows red luminance with blue and near UV excitation, with a peak emission wavelength around 615 nm and a peak excitation wavelength around 395 nm In a 20 wt % solution in toluene the product shows approximately 27% quantum yield (QY).

### Example 34

### Si+Ti+Al+Zn+Eu

3.11 g europium acetate hydrate, 1.64 g zinc acetate hydrate, 6.10 g titanium n-butoxide, 2.22 g aluminum sec-butoxide, 1.91 g diphenylmethylmethoxysilane, and 30 g of toluene are charged into a 500 mL 3-neck flask and stirred at refluxing temperature (about 105° C.) for 120 minutes. A pre-hydrolyzed siloxane solution is prepared by mixing 2.45 g phenylmethyldimethoxysilane, 2.68 g phenyltrimethoxysilane, 15 g toluene and 0.85 g 0.1N HCl and sonicating the mixture for a total of 30 minutes. Then this pre-hydrolyzed siloxane solution is added into the flask drop-wise. 10.9 g 4% water in n-butanol solution is also added drop-wise. The solution is stirred at refluxing temperature for another 60 minutes before removing the solvents using a rotary evaporation at 80° C. and 5 mm Hg. A total amount of H₂O is ˜110%. The product is a white solid with a composition of Ti_{0.2}Al_{0.2}Zn_{0.1}Eu_{0.1}D^{PhMe}_{0.15}T^{Ph}_{0.15}M^{Ph2Me}_{0.1}, soluble in many organic solvents such as toluene, THF, and chloroform. The product shows red luminance with blue and near UV excitation, with a peak emission wavelength around 615 nm and a peak excitation wavelength around 395 nm. In a 2 wt % solution in toluene the product shows approximately 15% quantum yield (QY).

### Example 35

### Si+Ti+Y+Eu

1.787 g europium acetate hydrate, 3.505 g titanium n-butoxide, 1.541 g yttrium butoxide, and 17 g of toluene plus 8 g butanol are charged into a 500 mL 3-neck flask and stirred at 70° C. for 120 minutes. A pre-hydrolyzed siloxane solution is prepared by mixing 0.699 g phenylmethyldimethoxysilane, 0.276 g phenyltrimethoxysilane, 5 g toluene and 0.423 g 0.1N HCl and sonicating the mixture for a total of 30 minutes. Then this pre-hydrolyzed siloxane solution is added into the flask drop-wise. 3.245 g of 5% water in n-butanol solution is also added drop-wise. The solution is stirred at room temperature for another 120 minutes before removing the solvents using a rotary evaporation at 65° C. and 1 mbar. A total amount of H₂O is ˜110%. The product is a white solid with a composition of Ti_{0.55}Y_{0.05}Eu_{0.2}D^{PhMe}_{0.15}T^{Ph}_{0.05}, soluble in many organic solvents such as toluene, THF, and chloroform. The product shows red luminance with blue and near UV excitation, with a peak emission wavelength around 615 nm and a peak excitation wavelength around 395 nm. In a 2 wt % solution in toluene the product shows approximately 51% quantum yield (QY).

### Example 36

### Si+Ti+Mn+Eu

1.896 g europium acetate hydrate, 0.134 g manganese acetate hydrate, 5.394 g titanium n-butoxide, and 30 g of toluene plus 10 g n-butanol are charged into a 500 mL 3-neck flask and stirred at 70° C.) for 200 minutes. The solution turns yellow-orange. A pre-hydrolyzed siloxane solution is prepared by mixing 0.741 g phenylmethyldimethoxysilane, 0.270 g phenyltrimethoxysilane, 5 g toluene and 0.451 g 0.1N HCl and sonicating the mixture for a total of 30 minutes. Then this pre-hydrolyzed siloxane solution is added into the flask drop-wise. 2.881 g of 5% water in n-butanol solution is also added drop-wise. The solution is stirred at room temperature for another 120 minutes before removing the solvents using a rotary evaporation at 65° C. and 1 mbar. A total amount of H₂O is ˜110%. The product is a grey solid with a composition of Ti_{0.58}Mn_{0.02}Eu_{0.2}D^{PhMe}_{0.15}T^{Ph}_{0.05}, soluble in many organic solvents such as toluene, THF, and chloroform. This product has improved absorption in the near UV to blue light (350-450 nm). The peak emission wavelength is around 615 nm with approximately 2% quantum yield (QY) under 395 nm excitation.

### Example 37

### Si+Ti+Ag+Eu

1.891 g europium acetate hydrate, 0.038 g silver neodecanoate, 5.508 g titanium n-butoxide, and 30 g of toluene plus 10 g n-butanol are charged into a 500 mL 3-neck flask and stirred at 70° C. for 90 minutes. The solution turns brown. A pre-hydrolyzed siloxane solution is prepared by mixing 0.757 g phenylmethyldimethoxysilane, 0.273 g phenyltrimethoxysilane, 5 g toluene and 0.508 g 0.1N HCl and sonicating the mixture for a total of 30 minutes. Then this pre-hydrolyzed siloxane solution is added into the flask drop-wise. 2.965 g of 5% water in n-butanol solution is also added drop-wise. The solution is stirred at room temperature for another 120 minutes before removing the solvents using a rotary evaporation at 65° C. and 1 mbar. A total amount of H₂O is ˜110%. The product is a grey solid with a composition of Ti_{0.595}Ag_{0.005}Eu_{0.2}D^{PhMe}_{0.15}T^{Ph}_{0.05}, soluble in many organic solvents such as toluene, THF, and chloroform. This composition is highly absorptive in the near UV and blue range (380-500 nm). The peak emission wavelength is around 615 nm with approximately 25% quantum yield (QY) under 395 nm excitation.

### Example 38

### Si+Ti+La+Eu

1.880 g europium acetate hydrate, 0.105 g terbium acetate hydrate, 5.426 g titanium n-butoxide, and 30 g of toluene plus 10 g n-butanol are charged into a 500 mL 3-neck flask and stirred at 70° C. for 150 minutes. A pre-hydrolyzed siloxane solution is prepared by mixing 0.737 g phenylmethyldimethoxysilane, 0.265 g phenyltrimethoxysilane, 5 g toluene and 0.470 g 0.1N HCl and sonicating the mixture for a total of 30 minutes. Then this pre-hydrolyzed siloxane solution is added into the flask drop-wise. 3.350 g of 5% water in n-butanol solution is also added drop-wise. The solution is stirred at room temperature for another 120 minutes before removing the solvents using a rotary evaporation at 65° C. and 1 mbar. A total amount of H₂O is ˜110%. The product is a white solid with a composition of Ti_{0.598}La_{0.01}Eu_{0.2}D^{PhMe}_{0.15}T^{Ph}_{0.05}, soluble in many organic solvents such as toluene, THF, and chloroform. The product shows red luminance with blue and near UV excitation, with a peak emission wavelength around 615 nm and a peak excitation wavelength around 395 nm. In a 2 wt % solution in toluene the product shows approximately 70% quantum yield (QY).

### Example 39

### Si+Ti+Gd+Eu

1.809 g europium acetate hydrate, 0.458 g gadolinium acetate hydrate, 4.889 g titanium n-butoxide, and 25 g of toluene plus 10 g n-butanol are charged into a 500 mL 3-neck flask and stirred at 70° C. for 90 minutes. A pre-hydrolyzed siloxane solution is prepared by mixing 0.717 g phenylmethyldimethoxysilane, 0.267 g phenyltrimethoxysilane, 5 g toluene and 0.346 g 0.1N HCl and sonicating the mixture for a total of 30 minutes. Then this pre-hydrolyzed siloxane solution is added into the flask drop-wise. 2.974 g of 5% water in n-butanol solution is also added drop-wise. The solution is stirred at room temperature for another 120 minutes before removing the solvents using a rotary evaporation at 65° C. and 1 mbar. A total amount of H₂O is ˜110%. The product is a white solid with a composition of Ti_{0.55}Gd_{0.05}Eu_{0.2}D^{PhMe}_{0.15}T^{Ph}_{0.05}, soluble in many organic solvents such as toluene, THF, and chloroform. The product shows red luminance with blue and near UV excitation, with a peak emission wavelength around 615 nm and a peak excitation wavelength around 395 nm. In a 2 wt % solution in toluene the product shows approximately 57% quantum yield (QY).

### Example 40

### Si+Ti+Tb+Eu

1.889 g europium acetate hydrate, 0.020 g terbium acetate hydrate, 5.551 g titanium n-butoxide, and 30 g of toluene plus 20 g n-butanol are charged into a 500 mL 3-neck flask and stirred at 70° C. for 90 minutes. A pre-hydrolyzed siloxane solution is prepared by mixing 0.745 g phenylmethyldimethoxysilane, 0.278 g phenyltrimethoxysilane, 5 g toluene and 0.438 g 0.1N HCl and sonicating the mixture for a total of 30 minutes. Then this pre-hydrolyzed siloxane solution is added into the flask drop-wise. 4.079 g of 5% water in n-butanol solution is also added drop-wise. The solution is stirred at room temperature for another 120 minutes before removing the solvents using a rotary evaporation at 65° C. and 1 mbar. A total amount of H₂O is ˜110%. The product is a white solid with a composition of Ti_{0.598}Tb_{0.002}Eu_{0.2}D^{PhMe}_{0.15}T^{Ph}_{0.05}, soluble in many organic solvents such as toluene, THF, and chloroform. The product shows red luminance with blue and near UV excitation, with a peak emission wavelength around 615 nm and a peak excitation wavelength around 395 nm. In a 2 wt % solution in toluene the product shows approximately 55% quantum yield (QY).

### Example 41

### Si+Ti+Eu

1.372 g of europium isopropoxide (prepared according to a procedure published in U.S. Pat. No. 4,507,245 from anhydrous europium acetate and sodium isopropoxide) is added to 3.316 g of titanium isopropoxide in 40 ml of anhydrous toluene and 20 ml of anhydrous isopropanol. The solution is cooled down to 0-5° C. and 6.883 g of a resin is added. This resin has the formula M_{0.43}Q_{0.57} wherein Mₙ=3230 g/mol and may be prepared according to techniques taught by Daudt in U.S. Pat. No. 2,676,182, which is expressly incorporated herein by reference relative to such techniques. The solution is heated to 80° C. for 1 hour after that it is cooled down to 0-5° C. again and 0.509 g of water in 15 ml of isopropanol is added drop wise over 2-3 hours. The solution is warmed to ambient overnight and finally heated to 80° C. for 1 hour. A total amount of H₂O is ˜100%. The clear solution is filtered through 0.2 μm PTFE filter and solvents are removed first using a rotary evaporation at 80° C. and 15 mm Hg, for 30 min. The product is a white powdery solid with a composition of Ti_{0.7}Eu_{0.25}MQ⁴⁰⁷_{0.05}, soluble in many organic solvents such as toluene, THF, and chloroform. The product shows orange or red luminance with blue and near UV excitation, with a peak emission wavelength around 615 nm and a peak excitation wavelength around 395 nm The quantum yield of this Example is determined in an 8.4 wt % solution of the Example in toluene and is approximately 10% QY.

### Example 42

### Si+Ti+Eu

1.365 g of europium isopropoxide is added to 3.535 g of titanium isopropoxide in 40 ml of anhydrous toluene and 20 ml of anhydrous isopropanol and the solution is cooled down to 0-5° C. A pre-hydrolyzed siloxane solution is prepared by mixing 9.130 g of diphenylmethoxysilylethyl terminated polydimethylsiloxane, 20 ml of isopropanol and 0.693 g 0.1N HCl and treating the mixture in the ultra sonic bath for a total of 30 min. The pre-hydrolyzed siloxane solution is drop wise added over 1 hour after that the solution is stirred at ambient overnight and then heated to 80° C. for 1 hour. A small amount of precipitate forms which is removed by centrifuge and filtering of the supernatant solution through a 0.45 μm PTFE filter. The solvents are removed first using a rotary evaporation at 80° C. and 15 mm Hg, for 30 min The product is a white powdery solid with a composition of Ti_{0.51}Eu_{0.17}M^{Ph2}_{0.32}, soluble in many organic solvents such as toluene, THF, and chloroform. The product shows orange or red luminance with blue and near UV excitation, with a peak emission wavelength around 615 nm and a peak excitation wavelength around 395 nm The quantum yield of this Example is determined in an 8.4 wt % solution of the Example in toluene and is approximately 13% QY.

### Example 43

### Si+Ti+Eu

1.372 g of europium isopropoxide is added to 2.961 g of titanium isopropoxide in 40 ml of anhydrous toluene and 20 ml of anhydrous isopropanol and the solution is cooled down to 0-5° C. Then 1.014 g of diphenyldisilanol is added followed by drop wise addition of 0.310 g pre-hydrolyzed phenyltrimethoxysilane and 0.499 g 0.1N HCl in 10 ml of isopropanol by treating the mixture in a ultra sonic bath for a total of 30 min A total amount of H₂O is ˜100%. The solution is allowed to warm up to ambient and stirred overnight and then heated to 80° C. for 1 hour. A small amount of precipitate forms which is removed by centrifuge and filtering of the supernatant solution through a 0.45 μm PTFE filter. Solvents are removed first using a rotary evaporation at 80° C. and 15 mm Hg. The product is a white powdery solid with a composition of Ti_{0.5}Eu_{0.2}M^{Ph2}_{0.225}T^{Ph}_{0.075} soluble in many organic solvents such as toluene, THF, and chloroform. The product shows orange or red luminance with blue and near UV excitation, with a peak emission wavelength around 615 nm and a peak excitation wavelength around 395 nm The quantum yield of this Example is determined in an 8.4 wt % solution of the Example in toluene and is approximately 4% QY.

### Example 44

### Si+Zr+Tb

4.55 g terbium acetate hydrate, 21.37 g NBZ solution (80% zirconium tetrabutoxide and 20% 1-butanol), and 50 g toluene are charged into a 250 ml 3-neck flask and refluxed at 107° C. for 80 minutes. A prehydrolyzed siloxane solution is prepared by mixing 7.11 g phenylmethyldimethoxysilane, 3.31 g phenyltrimethoxysilane, 20 g toluene, 5 g butanol, and 2.23 g 0.1N HCl and sonicating the combination for 30 minutes. The prehydrolyzed siloxane solution is added to the flask and the solution is continued refluxing for 30 minutes. The total amount of H₂O is ˜110%. The solution is maintained at refluxing temperature for 30 minutes. Solvent is removed using a rotary evaporator at 75° C. and 1 mbar. The product is a white solid with a composition of Tb_{0.10}Zr_{0.40}D^{PhMe}_{0.35}T^{Ph}_{0.15}, soluble in many organic solvents, such as butyl acetate, toluene, THF, and chloroform. This materials has several excitation peaks in the range of 310-380 nm, and emit at 487, 543, 583 and 620 nm In a 5 wt % solution in toluene the product shows approximately 6% quantum yield (QY).

The aforementioned examples demonstrate that the composition of this invention has excellent solubility and quantum yield.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

1. A polyheterosiloxane composition comprising:
(A) a first metal (M1),
(B) a second metal (M2),
(C) siloxy units having the formula (R¹₃SiO_{1/2}), (R¹₂SiO_{2/2}), (R¹SiO_{3/2}), and/or (SiO_{4/2})
wherein R¹ is independently a hydrocarbon or halogenated hydrocarbon group comprising 1 to 30 carbon atoms,
wherein the mole fractions of (A), (B), and (C) relative to each other is of the formula [(M1)]ₐ[(M2)]_{b}[R¹₃SiO_{1/2}]ₘ[R¹₂SiO_{2/2}]_{d}[R¹SiO_{3/2}]ₜ[SiO_{4/2}]_{q},
wherein a is from 0.001 to 0.9, b is from 0.001 to 0.9, m is from zero to 0.9, d is from zero to 0.9, t is from zero to 0.9, and q is from zero to 0.9,
wherein m, d, t, and q cannot all be zero and the sum of a+b+m+d+t+q≈1, and
wherein at least one of (M1) and (M2) is a lanthanide metal
wherein said composition exhibits a quantum yield of at least 0.05%.

2. The polyheterosiloxane composition of claim 1 wherein one of (M1) and (M2) is a non-lanthanide metal and the other of (M1) and (M2) is a lanthanide metal.

3. The polyheterosiloxane composition of claim 2 wherein the mole fractions of (A), (B), and (C) relative to each other is of the formula [(M1)]ₐ[(M2)]_{b}[R¹₂SiO_{2/2}]_{d}[R¹SiO_{3/2}]ₜ wherein (M1) is a non-lanthanide metal and a is from 0.1 to 0.9, wherein (M2) is a lanthanide metal and b is from 0.001 to 0.5, and wherein each of d and t is independently from 0.1 to 0.9.

4. The polyheterosiloxane composition of claim 1 wherein (M1) is chosen from Ti, Zr, Al, Ge, Ta, Nb, Sn, Hf, In, Sb, Fe, V, Sb, W, Te, Mo, Ga, Cu, Cr, Mg, Ca, Ba, Sr, Y and Sc.

5. The polyheterosiloxane composition of claim 1 wherein (M1) is chosen from Ti, Zr, or Al.

6. The polyheterosiloxane composition of claim 1 wherein (M1) is Ti.

7. The polyheterosiloxane composition of claim 1 wherein (M1) is Ti and (M2) comprises Eu and Zn.

8. The polyheterosiloxane composition of claim 1 wherein both of (M1) and (M2) are each independently selected lanthanide metals.

9. The polyheterosiloxane composition of claim 8 wherein the mole fractions of (A), (B), and (C) relative to each other is of the formula [(M1)]ₐ[(M2)]_{b}[R¹₂SiO_{2/2}]_{d}[R¹SiO_{3/2}]ₜ wherein a and b are each independently from 0.001 to 0.5, and wherein each of d and t is independently from 0.1 to 0.9.

10. The polyheterosiloxane composition of claim 9 wherein (M1) and (M2) are each independently chosen from Gd, Tb, Dy, Ho, Tm, and Lu.

11. The polyheterosiloxane composition of claim 9 wherein (M1) and (M2) are each independently chosen from Eu, Yb, Er, Nd, Dy, Sm, or Tb.

12. The polyheterosiloxane composition of claim 1 having a quantum yield of at least 10%.

13. The polyheterosiloxane composition of claim 1 having a quantum yield of at least 60%.

14. The polyheterosiloxane composition of claim 1 comprising at least 30% by weight of (A), (B), and (C).

15. (canceled)

16. The polyheterosiloxane composition of claim 1 comprising at least 70% by weight of (A), (B), and (C).

17. The polyheterosiloxane composition of claim 1 wherein the polyheterosiloxane composition emits light having a wavelength of 400 to 1700 nm when excited by a light source having a wavelength of 200 to 1000 nm with a photon quantum yield efficiency of at least 0.1%, with the proviso that the emitted light has a longer wavelength than the excitation light source.

18-26. (canceled)

27. A silicone composition comprising the polyheterosiloxane composition of claim 1 and a silicone fluid.

28. A method for preparing the polyheterosiloxane composition of any preceding claim comprising the step of reacting:
(A′) a metal (M3) alkoxide,
(B′) an optional hydrolyzable metal (M4) salt,
(C′) a silicon-containing material comprising at least one of (C′1) organosiloxane having an average formula (II) R⁵_{g}(R⁶O)_{f}SiO_{(4-(f+g))/2} or (C′2) silane having a general formula (III) R⁵ₕSiZ′ᵢ,
wherein each R⁵ is an independently selected hydrogen atom, alkyl group having 1 to 18 carbon atoms, alkenyl group having from 2 to 18 carbon atoms, aryl group having from 6 to 12 carbon atoms, epoxy group, amino group, or carbinol group, provided that at least one R⁵ is independently a hydrocarbon or halogenated hydrocarbon group including 1 to 30 carbon atoms,
wherein Z′ is OR⁶,
wherein at least one R⁶ is a hydrogen atom, and
wherein the subscript f is a value from 0.1 to 3, g is a value from 0.5 to 3, and (f+g) is a value from 0.6 to 3.9, h is a value from 0 to 3, i is a value from 1 to 4 and (h+i) equals 4, and
(D) an amount of water that provides between 50 and 200% necessary to hydrolyze and condense hydrolyzable groups of (A′) and optionally (B′),
wherein at least one of (M3) and (M4) is a lanthanide metal.

29. The method of claim 28 wherein the step of reacting is further defined as reacting (A′), (B′), (C′) and (D).

30. The method of claim 28 wherein (A′) and (B′) are reacted with (D) water to form a mixed metal oxide solution including M3-O-M4 oxo-bonds, and wherein the method further comprises the step of reacting the mixed metal oxide solution with (C′1) or (C′2) to form the polyheterosiloxane composition, wherein the total amount of water added is from 50 to 200% of an amount theoretically necessary for the hydrolysis and condensation of hydrolyzable groups of (A′), (B′), and (C′).

31. The method of claim 28 wherein (A′) has the formula (I) R¹ₖM3Oₙ Xₚ (OR²)ᵥ₁₋ₖ₋ₚ₋₂ₙ, M3 is chosen from Ti, Al, Ge, Zr, Sn, Cr, Ca, Ba, Sb, Cu, Ga, Hf, In, Fe, Mg, Mo, Nb, Ce, Y, Sr, Ta, Te, W, V, Sc, La, Pr, Nd, Pm, Sm, Eu, Gd, Tb, Dy, Ho, Er, Tm, Yb, and Lu, each X is independently chosen from carboxylate ligands, organosulfonate ligands, organophosphate ligands, β-diketonate ligands, and chloride ligands, subscript v1 is the oxidation state of M3, m is a value from 0 to 3, n is a value from 0 to 2, p is a value from 0 to 3, each R¹ is a monovalent alkyl group having from 1 to 18 carbon atoms, each R² is an independently selected monovalent alkyl group having from 1 to 6 carbon atoms, aryl group having from 6 to 8 carbon atoms, or a polyether group having a general formula (VI) —(R³⁰)ⱼR⁴, j is a value from 1 to 4, each R³ is an independently selected divalent alkylene group having from 2 to 6 carbon atoms, and R⁴ is an independently selected hydrogen atom or monovalent alkyl group having from 1 to 6 carbon atoms.

32. (canceled)

33. The method of claim 28 wherein (B′) is chosen from (B′1) a non-hydrated metal salt having a general formula (IV) R⁷ₑM4(Z)_{(v2-e)/w} and (B′2) a hydrated metal salt having a general formula (V) M4(Z)_{v2/w}.xH₂O, (M4) is a lanthanide metal, v2 is the oxidation state of M4, w is the oxidation state of Z, Z is independently chosen from carboxylates, β-diketonates, fluorides, chlorides, bromides, iodides, organic sulfonates, nitrates, nitrites, sulphates, sulfites, cyanides, phosphites, phosphates, organic phosphites, organic phosphates, and oxalates, each R⁷ is an independently selected alkyl group having 1 to 18 carbon atoms, alkenyl group having from 2 to 8 carbon atoms, or aryl group having from 6 to 8 carbon atoms, e is a value from 0 to 3 and x is a value from 0 to 12.

34-35. (canceled)
